(19) United States
(12) Patent Application Publication
(10) Pub. No.: US 2026/0149541 A1
(43) Pub. Date: May 28, 2026

(54) PARTIAL SUBBAND REPORTING BASED ON LOW-DENSITY CHANNEL STATE INFORMATION RECEIVED SIGNAL AND CHANNEL ESTIMATION ACCURACY

(71) Applicant: QUALCOMM Incorporated, San Diego, CA (US)

(72) Inventors: Chenxi HAO, Beijing (CN); Rui HU, Beijing (CN); Taesang YOO, San Diego, CA (US); Hao XU, Beijing (CN)

(21) Appl. No.: 19/114,411

(22) PCT Filed: Oct. 5, 2023
(86) PCT No.: PCT/CN2023/123100

§ 371 Date: Mar. 21, 2025

(30) Foreign Application Priority Data
Nov. 11, 2022 (WO) PCT/CN2022/131408

(51) Int. Cl. H04L 5/00

(52) U.S. Cl. CPC H04L 5/0051

(57) ABSTRACT

A device may receive, from a base station, a channel state information (CSI) reference signal on at least one of a first set of frequency units or a first set of antenna ports. The first set of frequency units or the first set of antenna ports may include less than all available frequency units or less than all available antenna ports. The device may generate a CSI based on the CSI reference signal and transmit information associated with the CSI on a second set of frequency units or a second set of antenna ports for use in reconstructing the CSI on a third set of frequency units or a third set of antenna ports. The second set of frequency units or the second set of antenna ports may include less than all available frequency units or less than all available antenna ports.

### FIELD

The present disclosure generally relates to a new approach to reporting channel state information for a partial set of channel resources such that the full channel state associated with the full set of channel resources can be determined based on the channel state information for the partial set of channel resources, thus reducing the overhead necessary to report the state of the channel.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Artificial intelligence (AI) and ML based algorithms may be incorporated into the 5G. 6G and future standards to improve telecommunications and data services.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for generating the channel state information for at least one of a set of frequency units or a set of antenna ports based on channel state information feedback on at least one of a partial set of frequency units or a partial set of antenna ports. Performing channel estimation when using legacy functions can become a bottleneck in channel state feedback performance, such as in a scenario when a large number (e.g., thousands) of antennas and transmission units are equipped on a base station for communication with one or more user equipment (UE). For example, a conventional channel state information (CSI) reference signal (CSI-RS) occupies one resource element (RE) per antenna port per resource block (RB), which results in a large overhead. The CSI-RS is the reference signal used for channel measurement and generating CSI feedback.

Systems and techniques are described herein that utilize less than all available resources and/or antenna ports for transmitting CSI. The systems and techniques can use a low-density CSI-RS for generating a partial CSI report that facilitates full CSI generation at a network entity (e.g., a base station). For example, a UE can receive a CSI-reference signal (CSI-RS) on a first set of frequency units (e.g., RBs or subbands) and/or a first set of antenna ports. The UE can utilize a machine learning-based encoder trained to generate a representation of CSI (e.g., a latent representation of the CSI), which can be included in a CSI report of channel state feedback (CSF). The UE can generate the CSI on a second set of frequency units and/or a second set of antenna ports, which can include less than all available frequency units and antenna ports. A base station receiving the CSI feedback (e.g., the latent representation of the CSI) can reconstruct the CSI (e.g., using a machine learning-based decoder) on third set of frequency units and/or a third set of antenna ports (e.g., a full set of frequency units and antenna ports). For example, the third set is a superset of the second set. Such an approach enables CSI feedback to be generated and transmitted on a reduced set of frequency units and/or antenna ports, while allowing the CSI to be extrapolated for a full set of frequency units and antenna ports.

In some aspects, the techniques described herein relate to a method of wireless communications at a user equipment (UE), the method including: receiving, from a base station, a channel state information (CSI) reference signal on at least one of a first set of frequency units or a first set of antenna ports, wherein at least one of the first set of frequency units or the first set of antenna ports includes at least one of less than all available frequency units or less than all available antenna ports; generating CSI based on the CSI reference signal; and transmitting, from the UE to the base station, information associated with the CSI on at least one of a second set of frequency units or a second set of antenna ports for use in reconstructing the CSI on at least one of a third set of frequency units or a third set of antenna ports, wherein at least one of the second set of frequency units or the second set of antenna ports includes at least one of less than all available frequency units or less than all available antenna ports.

In some aspects, the techniques described herein relate to an apparatus (e.g., such as a UE) for wireless communication, the apparatus including: at least one memory; and at least one processor coupled to the at least one memory and configured to: receive, from a base station, a channel state information (CSI) reference signal on at least one of a first set of frequency units or a first set of antenna ports, wherein at least one of the first set of frequency units or the first set of antenna ports includes at least one of less than all available frequency units or less than all available antenna ports; generate CSI based on the CSI reference signal; and transmit, to the base station, information associated with the CSI on at least one of a second set of frequency units or a second set of antenna ports for use in reconstructing the CSI on at least one of a third set of frequency units or a third set of antenna ports, wherein at least one of the second set of frequency units or the second set of antenna ports includes at least one of less than all available frequency units or less than all available antenna ports.

In some aspects, the techniques described herein relate to a non-transitory computer-readable storage medium including instructions stored thereon which, when executed by at least one processor, causes the at least one processor to: receive, from a base station, a channel state information (CSI) reference signal on at least one of a first set of frequency units or a first set of antenna ports, wherein at least one of the first set of frequency units or the first set of antenna ports includes at least one of less than all available frequency units or less than all available antenna ports; generate CSI based on the CSI reference signal; and transmit, to the base station, information associated with the CSI on at least one of a second set of frequency units or a second set of antenna ports for use in reconstructing the CSI on at least one of a third set of frequency units or a third set of antenna ports, wherein at least one of the second set of frequency units or the second set of antenna ports includes at least one of less than all available frequency units or less than all available antenna ports.

In some aspects, the techniques described herein relate to an apparatus for wireless communications including: means for receiving, from a base station, a channel state information (CSI) reference signal on at least one of a first set of frequency units or a first set of antenna ports, wherein at least one of the first set of frequency units or the first set of antenna ports includes at least one of less than all available frequency units or less than all available antenna ports; means for generating CSI based on the CSI reference signal; and means for transmitting, to the base station, information associated with the CSI on at least one of a second set of frequency units or a second set of antenna ports for use in reconstructing the CSI on at least one of a third set of frequency units or a third set of antenna ports, wherein at least one of the second set of frequency units or the second set of antenna ports includes at least one of less than all available frequency units or less than all available antenna ports.

In some aspects, the techniques described herein relate to a method of wireless communication at a base station, the method including: transmitting, to a user equipment (UE), a channel state information (CSI) reference signal on at least one of a first set of frequency units or a first set of antenna ports, wherein at least one of the first set of frequency units or the first set of antenna ports includes at least one of less than all available frequency units or less than all available antenna ports; receiving, from the UE, information associated with CSI on at least one of a second set of frequency units or a second set of antenna ports, wherein at least one of the second set of frequency units or the second set of antenna ports includes at least one of less than all available frequency units or less than all available antenna ports; and generating, based on the information associated with the CSI, reconstructed CSI for at least one of a third set of frequency units or a third set of antenna ports.

In some aspects, the techniques described herein relate to an apparatus (e.g., such as a base station) for wireless communication, the apparatus including: at least one memory; and at least one processor coupled to the at least one memory and configured to: transmit, to a user equipment (UE), a channel state information (CSI) reference signal on at least one of a first set of frequency units or a first set of antenna ports, wherein at least one of the first set of frequency units or the first set of antenna ports includes at least one of less than all available frequency units or less than all available antenna ports; receive, from the UE, information associated with CSI on at least one of a second set of frequency units or a second set of antenna ports, wherein at least one of the second set of frequency units or the second set of antenna ports includes at least one of less than all available frequency units or less than all available antenna ports; and generate, based on the information associated with the CSI, reconstructed CSI for at least one of a third set of frequency units or a third set of antenna ports.

In some aspects, the techniques described herein relate to a non-transitory computer-readable storage medium including instructions stored thereon which, when executed by at least one processor, causes the at least one processor to: transmit, to a user equipment (UE), a channel state information (CSI) reference signal on at least one of a first set of frequency units or a first set of antenna ports, wherein at least one of the first set of frequency units or the first set of antenna ports includes at least one of less than all available frequency units or less than all available antenna ports; receive, from the UE, information associated with CSI on at least one of a second set of frequency units or a second set of antenna ports, wherein at least one of the second set of frequency units or the second set of antenna ports includes at least one of less than all available frequency units or less than all available antenna ports; and generate, based on the information associated with the CSI, reconstructed CSI for at least one of a third set of frequency units or a third set of antenna ports.

In some aspects, the techniques described herein relate to an apparatus for wireless communications including: means for transmitting, to a user equipment (UE), a channel state information (CSI) reference signal on at least one of a first set of frequency units or a first set of antenna ports, wherein at least one of the first set of frequency units or the first set of antenna ports includes at least one of less than all available frequency units or less than all available antenna ports; means for receiving, from the UE, information associated with CSI on at least one of a second set of frequency units or a second set of antenna ports, wherein at least one of the second set of frequency units or the second set of antenna ports includes at least one of less than all available frequency units or less than all available antenna ports; and means for generating, based on the information associated with the CSI, reconstructed CSI for at least one of a third set of frequency units or a third set of antenna ports.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 illustrates an example architecture of a neural network that may be used in accordance with some aspects of the present disclosure;

FIG. 6 is a block diagram illustrating an ML engine, in accordance with aspects of the present disclosure;

FIG. 7 illustrates a block diagram showing an encoder encoding input to generate a latent message transmitted to a decoder at a third Generation Partnership Project (3GPP) gNodeB (gNB) that generate an output based on the latent message, in accordance with aspects of the present disclosure;

FIG. 8 illustrates the low density use of the available resource blocks and antenna ports as well as example codes on a resource block, in accordance with aspects of the present disclosure;

FIG. 9 illustrates the use of separate functions to perform channel estimation, in accordance with aspects of the present disclosure;

FIG. 10 illustrates the process of generating channel state information from a channel state information reference signal, in accordance with aspects of the present disclosure;

FIG. 11 illustrates optional approaches for determining frequency units and antenna ports related to generating channel state information, in accordance with aspects of the present disclosure;

FIG. 12 is a block diagram illustrating encoder and decoder functions related to generating channel state information, in accordance with aspects of the present disclosure;

FIG. 13 is a block diagram illustrating encoder and decoder functions related to generating channel state information, in accordance with aspects of the present disclosure;

FIG. 14 illustrates further encoder and decoder functions related to generating channel state information, in accordance with aspects of the present disclosure;

FIG. 15 illustrates further encoder and decoder functions related to generating channel state information, in accordance with aspects of the present disclosure;

FIG. 16 is a flow diagram illustrating an example of a process for wireless communication, in accordance with aspects of the present disclosure;

FIG. 17 is a flow diagram illustrating an example of a process for wireless communication, in accordance with aspects of the present disclosure;

FIG. 18 is a block diagram illustrating autoencoder-based CSI feedback, in accordance with aspects of the present disclosure;

FIG. 19 is a graph showing squared generalized cosine similarity (SGCS) performance for channel estimation, in accordance with aspects of the present disclosure;

FIG. 20 illustrates a graph of an averaged SGCS performance for channel state information feedback (CSF), in accordance with aspects of the present disclosure;

FIG. 21 is a block diagram illustrating a proposed framework for CSF under low-density pilot, in accordance with aspects of the present disclosure;

FIG. 22 is a diagram illustrating an example of neural network architectures for a base station for implementing certain aspects of the present technology, in accordance with aspects of the present disclosure;

FIG. 23 is a diagram illustrating an example of a neural network architecture for a user equipment for implementing certain aspects of the present technology, in accordance with aspects of the present disclosure; and

FIG. 24 is a diagram illustrating an example of a system for implementing certain aspects of the present technology, in accordance with aspects of the present disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Various techniques are provided in reference with wireless technologies (e.g., The third Generation Partnership Project (3GPP) 5G/New Radio (NR) Standard) to provide improvements to wireless communications. Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a third Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

Channel State Information (CSI) feedback can be used by network entity (e.g., a base station such as a third Generation Partnership Project (3GPP) gNodeB (NB)) in a wireless communications system to determine channel conditions so as to schedule downlink data transmissions. For example, a user equipment (UE) can receive a CSI-Reference Signal (CSI-RS) from a base station (e.g., a gNB) and perform channel estimation based on the CSI-RS. According to the current 3GPP Standard, the CSI report configuration includes a codebook, which is used as a Precoding Matrix Indicator (PMI) dictionary from which a UE can report the best PMI codewords based on channel and/or interference measurement from the received CSI-RS. The UE can use a sequence of bits to report the PMI.

In some cases, Artificial Intelligence/Machine Learning (AI/ML)-based CSI feedback may use a CSI ML encoder and/or a CSI ML decoder to replace the PMI. For instance, a UE that intends to convey CSI to a gNB can use the CSI ML encoder (e.g., an encoder neural network model) to derive a compressed representation (also referred to as a latent representation or latent message) of the CSI for transmission to the gNB. The gNB may use the CSI ML decoder (e.g., a decoder neural network model) to reconstruct the target CSI from the compressed representation. The CSI ML encoder is analogous to the PMI searching algorithm in current system. The CSI ML decoder is analogous to the PMI codebook and is used to translate the CSI reporting bits to a PMI codeword.

A conventional CSI-RS occupies 1 resource element (RE) per port per resource block (RB). The example type of resource configuration can cause a large overhead, especially when a large number (e.g., thousands) of antenna and/or transmit resource units (TxRU) are equipped at a base station (e.g., for holographic multiple-input-multiple output (MIMO)) or other network device or entity (e.g., a reconfigurable intelligent surface (RIS), etc.).

In some case, low-density RSs may be achieved by an RB-comb pattern (e.g., a non-uniform RB pattern), or a (random) Tx-RB selection, or Nt ports multiplexed on L REs per RB via a learned cover-code (where Nt>L). For CSI feedback (or Channel State Feedback (CSF)) under low density CSI-RS, a decision can be made as to whether one should use an ML function that jointly performs channel estimation, or to use two separate functions (as is currently performed). One issue with using separate functions is that channel estimation may become a bottleneck, thus limiting the CSF performance

Further, for CSI feedback (or Channel State Feedback (CSF)) under low density CSI-RS, a decision can be made as to whether a UE should report CSI on less than all of the Tx-RB (or Tx-subband) resources or to report CSI for all resources. There can be issues with reporting CSI for all resources. For example, a UE can recover the channel for full resource, and can then perform compression again. However, some resources may have bad channel estimation quality, in which case no benefit is provided for the CSI report.

Systems, apparatuses, processes (also referred to as methods), and computer-readable media (collectively referred to herein as “systems and techniques”) are described herein for providing partial subband reporting based on low-density CSI-RSs and channel estimation accuracy. For instance, a UE can receive a CSI-RS transmission on a first set of frequency units (e.g., RB or subbands) from all available frequency resources and/or on a first set of antenna ports out of all available antenna ports. The UE can generate CSI feedback for a second set of frequency units and/or a second set of antenna ports, to facilitate the CSI generation or reconstruction (e.g., at a base station, such as a gNB) on a third set of frequency units and/or a third set of antenna ports. In some cases, the second set of frequency units and/or a second set of antenna ports is determined, based at least in part on the first set of frequency units and/or the first set of antenna ports, the third set of frequency units and/or the third set of antenna ports, a received signal power, an interference level, a channel estimation accuracy of the received CSI-RS, based on a gNB configuration (e.g., a configuration received from the gNB), any combination thereof, and/or other information. In some cases, the third set of frequency units and/or third set of antenna ports is the full set of available resources and/or ports, is a configured set of frequency units and/or ports, or is dependent at least in part on the second set of resources and/or ports. In some cases, the third set of frequency units and/or third set of antenna ports is equal to the second set of frequency units and/or the second set of antenna ports. The UE can then transmit a CSI report including a representation of the CSI (e.g., a latent representation generated by an ML encoder) to the base station.

A base station (e.g., a gNB) or a portion thereof (e.g., a central unit (CU), distributed unit (DU), radio unit (RU), Near-Real Time (Near-RT) radio access network (RAN) Intelligent Controller (RIC), or a Non-Real Time (Non-RT) RIC of the base station) can transmit the CSI-RS on the first set of frequency units and/or the first set of antenna ports. The base station (or portion thereof) can receive the CSI feedback (from the UE) for the second set of frequency units and/or on the second set of antenna ports. The base station (or portion thereof) can include an ML model (e.g., an ML-based encoder) that enables the determination of the CSI for a full set of resources based on CSI feedback received on a partial set of resources (e.g., frequency units on a set of antenna ports). For instance, the base station (or portion thereof) can generate a final CSI (e.g., by reconstructing the CSI using an ML encoder) for a third set of frequency units and/or a third set of antenna ports. As noted above, the third set of resources can be the total available frequency resource (e.g., full subbands of the bandwidth part (BWP)) and the third set of antenna ports can be all available antenna ports. In another example, the third set of frequency resources and/or antenna ports can be dependent at least in part on the second set of frequency resources and/or antenna ports.

One drawback of an approach of sending CSI for a full set of frequency resources and/or antenna ports is that some of the frequency resources (e.g., subbands) may have bad channel quality, while other portions of the frequency resources may have good channel quality. For example, some blocks that represent RBs on antenna ports can have good quality, while other blocks can represent RBs on antenna ports that have poor quality. If the system still reports the CSI for the full resource, the system may mix the good quality subband data with the poor quality subband data, which may degrade the compression efficiency of the CSI report. By not including the poor quality subband data, the compression efficiency for the good subband data can be improved. Using the systems and techniques described herein, a base station (e.g., a gNB) can recover or reconstruct CSI for the good subband data with accuracy, and can utilize a trained ML model (e.g., a trained neural network) to reconstruct the CSI for the full set of resources. The approach can selectively recover a subset of the full subband. Thus, in one scenario, when some of the RBs and/or antenna ports have a poor quality, the system may not even report on those and leave the determination of the CSI for those subbands to the base station to extrapolate. The base station can therefore reconstruct the CSI for the full set of resources based on a partial set of CSI data.

Additional aspects of the present disclosure are described in more detail below with respect to the figures. Illustrative aspects are also provided in Appendix A provided herewith.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IOT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

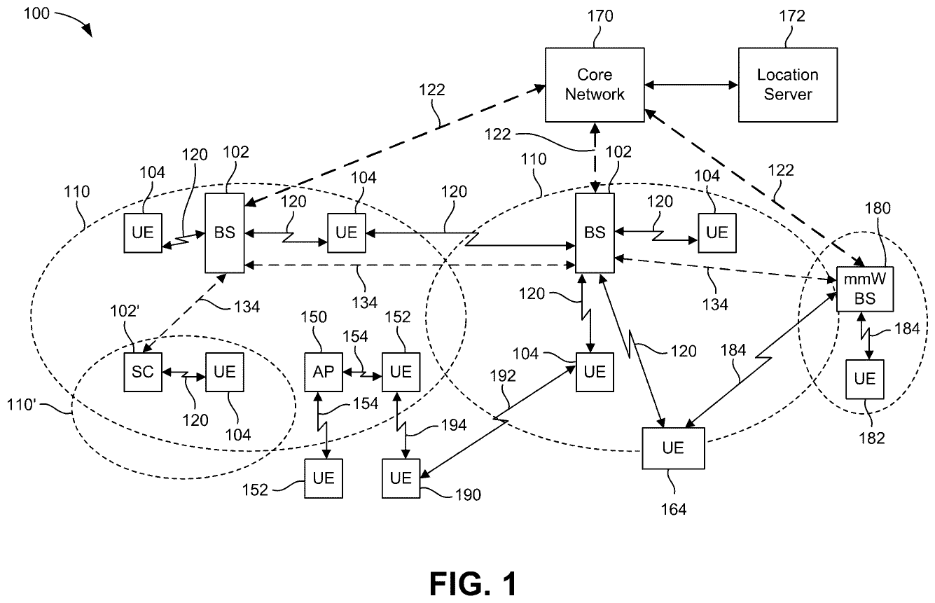

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station of the base stations 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IOT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While a neighboring macro cell base station of the base stations 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE of the UEs 104 to a base station of the base stations 102 and/or downlink (also referred to as forward link) transmissions from a base station of the base stations 102 to a UE of the UEs 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs of the UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in the referenced band may be referred to as a millimeter wave. Near mmW may extend down to a frequency of 3 GHz with a wavelength of 100 millimeters. The super high frequency (SHF) band extends between 3 GHZ and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations of the base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE of the UEs 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. In other words, different UEs 104/182 in a cell may have different downlink primary carriers. The same is true for the uplink primary carriers. The network is able to change the primary carrier of any UE 104/182 at any time. The change of the primary carrier is done, for example, to balance the load on different carriers. Because a “serving cell” (whether a PCell or an SCell) corresponds to a carrier frequency and/or component carrier over which some base station is communicating, the term “cell,” “serving cell.” “component carrier,” “carrier frequency,” and the like may be used interchangeably.

For example, still referring to FIG. 1, one of the frequencies utilized by the macro cell base stations of the base stations 102 may be an anchor carrier (or “PCell”) and other frequencies utilized by the macro cell base stations of the base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station of the base stations 102 and/or a UE of the UEs 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In one example, if the UE of the UEs 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE of the UEs 104 is being served in band ‘X’ or band ‘Y,’ because of the separate “Receiver 2,” the UE of the UEs 104 may measure band ‘Z’ without interrupting the service on band ‘X’ or band ‘Y.’

The wireless communications system 100 may further include a UE 164 that may communicate with a macro cell base station of the base stations 102 over a communication link 120 and/or the mmW base station 180 over an mmW communication link 184. For example, the macro cell base station of the base stations 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STAs 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

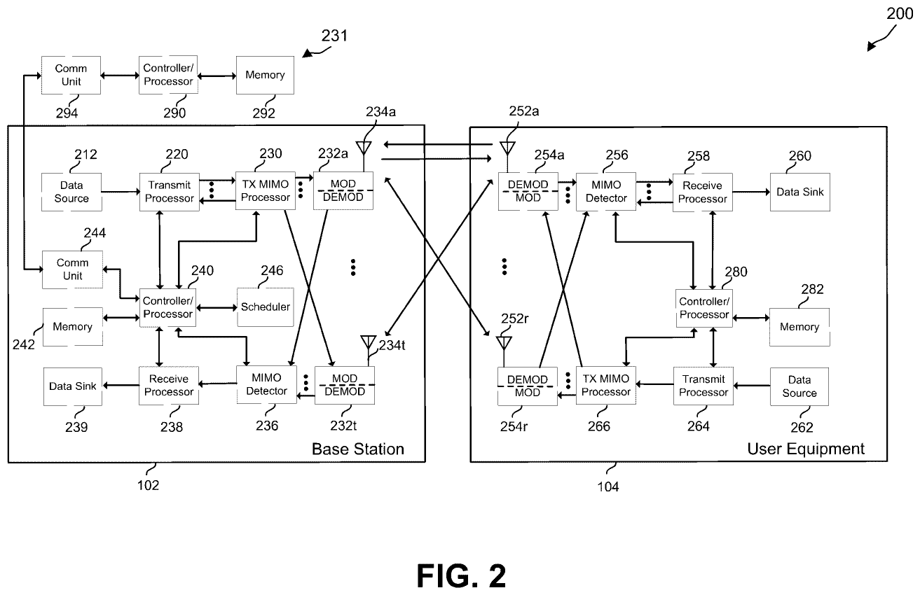

FIG. 2 shows a block diagram of a design of a base station of the base stations 102 and a UE of the UEs 104 that enable transmission and processing of signals exchanged between the UE and the base station, in accordance with some aspects of the present disclosure. Design 200 includes components of a base station of the base stations 102 and a UE of the UEs 104, which may be one of the base stations 102 and one of the UEs 104 in FIG. 1. A base station of the base stations 102 may be equipped with T antennas 234a through 234t, and UE of the UEs 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The MODs 232a through 232t are shown as a combined modulator-demodulator (MOD-DEMOD). In some cases, the modulators and demodulators may be separate components. Each modulator of the MODs 232a to 232t may process a respective output symbol stream, e.g., for an orthogonal frequency-division multiplexing (OFDM) scheme and/or the like, to obtain an output sample stream. Each modulator of the MODs 232a to 232t may further process (e.g., convert to analog, amplify, filter, and upconvert) the output sample stream to obtain a downlink signal. T downlink signals may be transmitted from MODs 232a to 232t via T antennas 234a through 234t, respectively. According to certain aspects described in more detail below, the synchronization signals may be generated with location encoding to convey additional information.

At a UE of the UEs 104, R antennas 252a through 252r may receive the downlink signals from a base station of the base stations 102 and/or other base stations and may provide received signals to demodulators (DEMODs) 254a through 254r, respectively. The DEMODs 254a through 254r are shown as a combined modulator-demodulator (MOD-DEMOD). In some cases, the modulators and demodulators may be separate components. Each demodulator of the DEMODs 254a through 254r may condition (e.g., filter, amplify, downconvert, and digitize) a received signal to obtain input samples. Each demodulator of the DEMODs 254a through 254r may further process the input samples (e.g., for OFDM and/or the like) to obtain received symbols. A MIMO detector 256 may obtain received symbols from all R of the DEMODs 254a through 254r, perform MIMO detection on the received symbols if applicable, and provide detected symbols. A receive processor 258 may process (e.g., demodulate and decode) the detected symbols, provide decoded data for UE of the UEs 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE of the UEs 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by DEMODs 254a through 254r (e.g., for DFT-s-OFDM, CP-OFDM, and/or the like), and transmitted to base station 102. At base station 102, the uplink signals from a UE of the UEs 104 and other UEs may be received by T antennas 234a through 234t, processed by DEMODs 254a through 254r, detected by a MIMO detector 236 if applicable, and further processed by a receive processor 238 to obtain decoded data and control information sent by a UE of the UEs 104. Receive processor 238 may provide the decoded data to a data sink 239 and the decoded control information to controller (processor) 240. A base station of the base stations 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station of the base stations 102 and the UE of the UEs 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

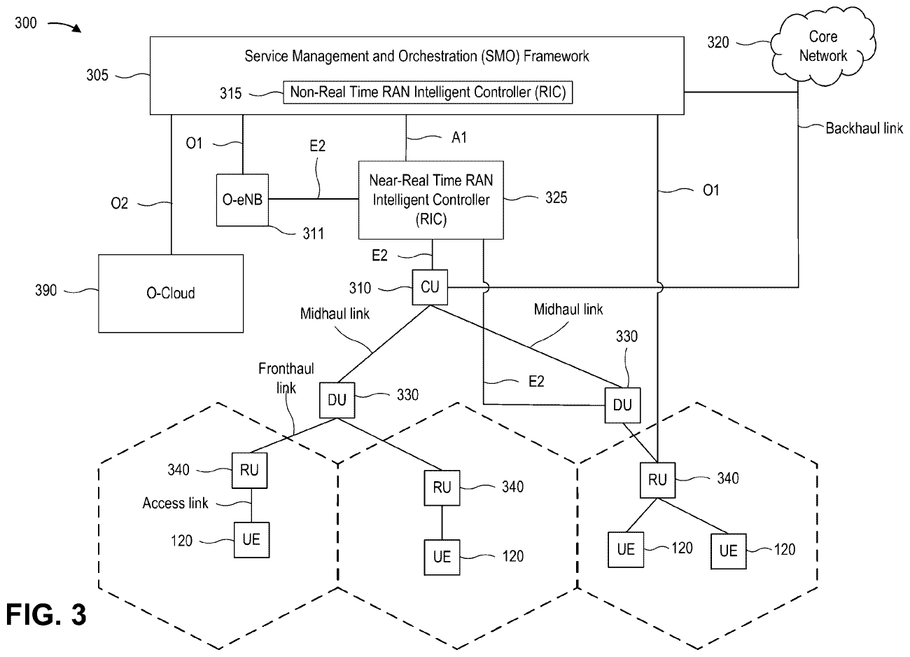

FIG. 3 shows a diagram illustrating an example disaggregated base station 300 architecture. The disaggregated base station 300 architecture may include one or more central unit (CU) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). One or more CU 310 may communicate with one or more distributed units (DU) 330 via respective midhaul links, such as an F1 interface. The DU 330 may communicate with one or more radio units (RU) 340 via respective fronthaul links. The RU 340 may communicate with respective UEs of the UEs 104 via one or more radio frequency (RF) access links. In some implementations, the UE of the UEs 104 may be simultaneously served by multiple RU 340.

Each of the units, e.g., the CUS 310, the DU 330, the RU 340, as well as the Near-RT RICs 325, the Non-RT RIC 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the one or more CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The one or more CU 310 may be configured to handle user plane functionality (i.e., Central Unit-User Plane (CU-UP)), control plane functionality (i.e., Central Unit-Control Plane (CU-CP)), or a combination thereof. In some implementations, the one or more CU 310 may be logically split into one or more CU-UP units and one or more CU-CP units. The CU-UP unit may communicate bidirectionally with the CU-CP unit via an interface, such as the E1 interface when implemented in an O-RAN configuration. The one or more CU 310 may be implemented to communicate with the DU 330, as necessary, for network control and signaling.

The DU 330 may correspond to a logical unit that includes one or more base station functions to control the operation of one or more RU 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RU 340. In some deployments, the RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 340 may be implemented to handle over the air (OTA) communication with one or more UEs of the UEs 104. In some implementations, real-time and non-real-time aspects of control and user plane communication with the RU 340 may be controlled by the DU 330. In some scenarios, the configuration may enable the DU 330 (which may be one or more DU) and the one or more CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, the DU 330, the RU 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RU 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, the DU 330 (or multiple DUs), or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

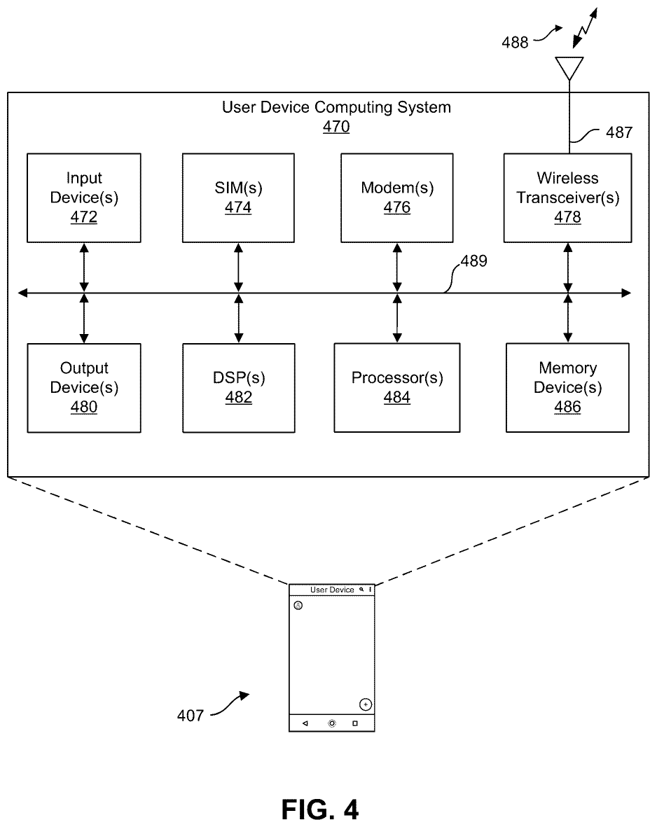

FIG. 4 illustrates an example of a computing system 470 of a wireless device 407. The wireless device 407 may include a client device such as a UE (e.g., UE of the UEs 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IOT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processor 484. The one or more processor 484 may include one or more CPUs, ASICs, FPGAs, APs, GPUs, VPUs, NSPs, microcontrollers, dedicated hardware, any combination thereof, and/or other processing device or system. The bus 489 may be used by the one or more processor 484 to communicate between cores and/or with the one or more memory devices 486.

The computing system 470 may also include one or more memory devices 486, one or more digital signal processors (DSPs) 482, one or more subscriber identity modules (SIMs) 474, one or more modem 476, one or more wireless transceivers 478, one or more antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as one or more modem 476, wireless transceiver(s) 478, and/or antenna 487. The one or more wireless transceiver 478 may transmit and receive wireless signals (e.g., the wireless signal 488) via one or more antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. One or more antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via one or more antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signal 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modem 476 may modulate one or more signals to encode information for transmission using the one or more wireless transceivers 478. The one or more modem 476 may also demodulate signals received by the one or more wireless transceiver 478 in order to decode the transmitted information. In some examples, the one or more modem 476 may include a Wi-Fi modem, a 4G (or LTE) modem, a 5G (or NR) modem, and/or other types of modems. The one or more modem 476 and the one or more wireless transceiver 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor 484 and/or the one or more DSP 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

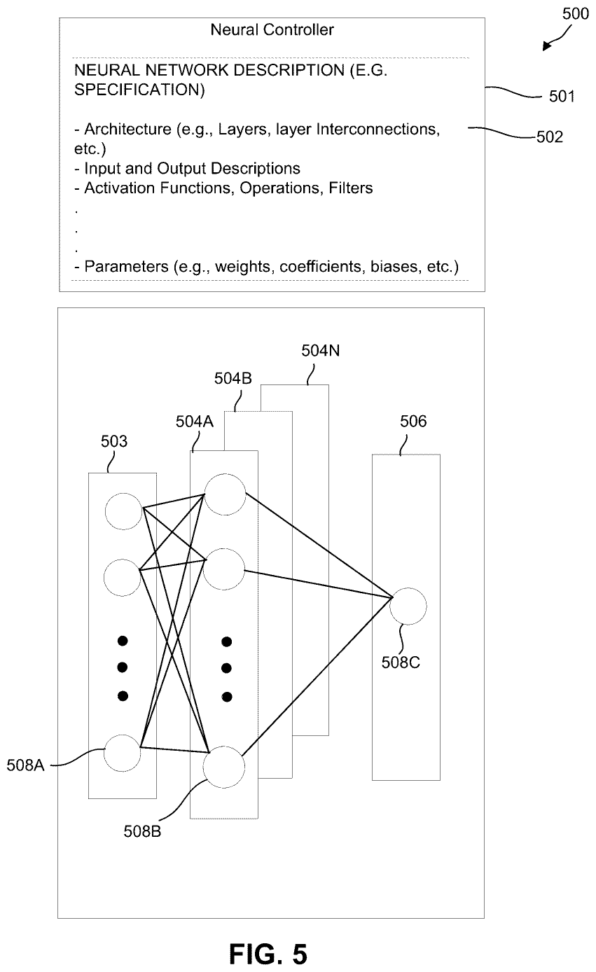

FIG. 5 illustrates an example architecture of a neural network 500 that may be used in accordance with some aspects of the present disclosure. The example architecture of the neural network 500 may be defined by an example neural network description 502 in neural controller 501. The neural network 500 is an example of a machine learning model that can be deployed and implemented at the base station 102, the central unit (CU) 310, the distributed unit (DU) 330, the radio unit (RU) 340 (which can be one or more RU), and/or the UE of the UEs 104. The neural network 500 can be a feedforward neural network or any other known or to-be-developed neural network or machine learning model.

The neural network description 502 can include a full specification of the neural network 500, including the neural architecture shown in FIG. 5. For example, the neural network description 502 can include a description or specification of architecture of the neural network 500 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 500 can reflect the neural architecture defined in the neural network description 502. The neural network 500 can include any suitable neural or deep learning type of network. In some cases, the neural network 500 can include a feed-forward neural network. In other cases, the neural network 500 can include a recurrent neural network, which can have loops that allow information to be carried across nodes while reading in input. The neural network 500 can include any other suitable neural network or machine learning model. One example includes a convolutional neural network (CNN), which includes an input layer and an output layer, with multiple hidden layers between the input and out layers. The hidden layers of a CNN include a series of hidden layers as described below, such as convolutional, nonlinear, pooling (for downsampling), and fully connected layers. In other examples, the neural network 500 can represent any other neural or deep learning network, such as an autoencoder, a deep belief nets (DBNs), a recurrent neural network (RNN), a generative-adversarial network (GAN), etc.

In the non-limiting example of FIG. 5, the neural network 500 includes an input layer 503, which can receive one or more sets of input data. The input data can be any type of data (e.g., image data, video data, network parameter data, user data, etc.). The neural network 500 can include hidden layers 504A through 504N (collectively “hidden layers 504” hereinafter). The hidden layers 504 can include n number of hidden layers, where n is an integer greater than or equal to one. The n number of hidden layers can include as many layers as needed for a desired processing outcome and/or rendering intent. In one illustrative example, any one of the hidden layers 504 can include data representing one or more of the data provided at the input layer 503. The neural network 500 further includes an output layer 506 that provides an output resulting from the processing performed by hidden layers 504. The output layer 506 can provide output data based on the input data.

In the example of FIG. 5, the neural network 500 is a multi-layer neural network of interconnected nodes. Each node can represent a piece of information. Information associated with the nodes is shared among the different layers and each layer retains information as information is processed. Information can be exchanged between the nodes through node-to-node interconnections between the various layers. The nodes of the input layer 503 can activate a set of nodes in the hidden layer 504A. For example, as shown, each input node of the input layer 503 is connected to each node of the hidden layer 504A. The nodes of the hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of the output layer 506, at which point an output can be provided. In some cases, while nodes (e.g., nodes 508A, 508B, 508C) in the neural network 500 are shown as having multiple output lines, a node can have a single output and all lines shown as being output from a node can represent the same output value.

In some cases, each node or interconnection between nodes can have a weight that is a set of parameters derived from training the neural network 500. For example, an interconnection between nodes can represent a piece of information learned about the interconnected nodes. The interconnection can have a numeric weight that can be tuned (e.g., based on a training data set), allowing the neural network 500 to be adaptive to inputs and able to learn as more data is processed.

The neural network 500 can be pre-trained to process the features from the data in the input layer 503 using different hidden layers 504 in order to provide the output through the output layer 506. For example, in some cases, the neural network 500 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned (e.g., meet a configurable threshold determined based on experiments and/or empirical studies).

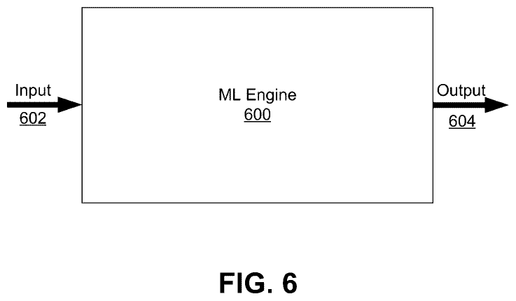

Increasingly ML (e.g., AI) algorithms (e.g., models) are being incorporated into a variety of technologies including wireless telecommunications standards. FIG. 6 is a block diagram illustrating an ML engine 600, in accordance with aspects of the present disclosure. As an example, one or more devices in a wireless system may include the ML engine 600. In some cases, ML engine 600 may be similar to neural network 500. In one example, ML engine 600 includes three parts, input 602 to the ML engine 600, the ML engine, and the output 604 from the ML engine 600. The input 602 to the ML engine 600 may be data from which the ML engine 600 may use to make predictions or otherwise operate on. As an example, an ML engine 600 configured to select an RF beam may take, as input 602, data regarding current RF conditions, location information, network load, etc. As another example, data related to packets sent to a UE, along with historical packet data may be input 602 to an ML engine 600 configured to predict a discontinuous reception (DRX) schedule for the UE. In some cases, the output 604 may be predictions or other information generated by the ML engine 600 and the output 604 may be used to configure a wireless device, adjust settings, parameters, modes of operations, etc. Continuing the previous examples, the ML engine 600 configured to select an RF beam may output 604 a RF beam or set of RF beams that may be used. Similarly, the ML engine 600 configured to predict a DRX schedule for the UE may output a DRX schedule for the UE.

In another example, the ML engine 600 may be an encoder used to compress channel state information (e.g., channel state information (CSI) or channel state feedback (CSF)) determined by a UE in order to generate a representation (e.g., a latent representation) of the control information. In another example, the ML engine 600 may be an encoder used by a network entity (e.g., a base station) to decode a representation (e.g., a latent representation) of the control information (e.g., CSI) generated by a UE.

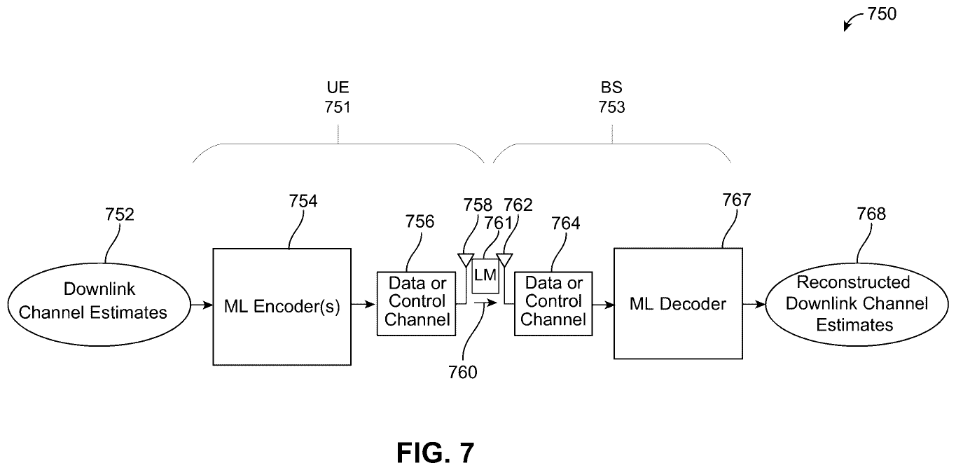

FIG. 7 is a diagram illustrating an example of a network 750 including a UE 751 and a base station e.g., a gNB or a portion of a gNB, such as a CU, DU, RU, etc. of a gNB having a disaggregated architecture). As shown in FIG. 7, downlink channel estimates 752 (e.g., CSI or CSF) are provided to an encoder 754 of the UE 751. The CSI encoder 754 encodes the CSI and the UE 751 transmits the encoded CSI (e.g., a latent representation of the CSI as a latent message 761, such as a feature vector representing the CSI) using antenna 758 via a data or control channel 756 over a wireless or air interface 760 to a receiving antenna 762 of the base station 753. In some cases, the UE 751 can transmit a latent message representing the CSI as the latent message 761. As noted above, the CSI encoder 754 can replace the PMI codebook which was used to translate the CSI reporting bits to a PMI codeword.

The encoded CSI or latent message 761 is provided via a data or control channel 764 to a CSI decoder 767 of the base station 753 that can decode the encoded CSI to generate a reconstructed downlink channel estimate 768 (or reconstructed CSI). In some cases, the base station 753 can then determine a precoding matrix, a modulation and coding scheme (MCS), and/or a rank associated with one or more antennas of the base station. Based on the precoding matrix, the MCS, and/or the rank, the base station 753 can determine a configuration of control resources (e.g., via a physical downlink control channel (PDCCH)) or data resources (e.g., via a physical downlink shared channel (PDSCH)).

The decoder output could be a number of different data structures. For example, the decoder output could be a downlink channel matrix (H), a transmit covariance matrix, downlink precoders (V), an interference covariance matrix (Rₙₙ), or a raw vs. whitened downlink channel. In some examples, when the encoder input is (H) (a channel matrix), the decoder output could be H (a channel matrix) or V (an eigen vector) or SV (eigen values times V). When the encoder input is an eigen vector V, the decoder output could be also an eigen vector V. When the encoder input is the inference covariance matrix Rₙₙ, the output could also be an interference covariance matrix Rₙₙ. The H or V values can correspond to a raw channel or to a channel pre-whitened by the UE 751 based on its demodulation filter.

The conventional CSI-RS occupies one resource element per antenna port per resource block. When there are many antenna or transmission radio distribution units (TxRU) equipped at a base station, the current transmission approach for the CSI-RS can require a large amount of overhead. The scenario of requiring a large amount of overhead can be particularly applicable to holographic multiple-in-multiple-out (MIMO) scenarios as well as reflective (or reconfigurable) intelligence surfaces (RISs). RISs or intelligent reflecting surfaces (IRS) are an emerging transmission technology for application to wireless communications. They can reconfigure the wireless propagation environment via software-control reflection. RISs can apply to networks such as 6G networks and materialize seamless connections and intelligent software-based control of the environment in wireless communication systems. Since RIS reflection beamforming prediction requires the perfect/imperfect channel knowledge, channel estimation is a crucial aspect for predicting RIS interaction matrices. In one context, RIS can be combined with machine learning (ML) techniques, which are particularly powerful in providing channel estimation.

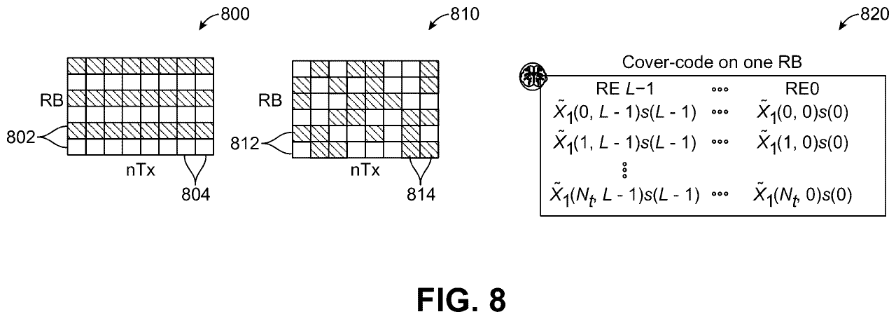

FIG. 8 shows several approaches to provide low-density reference signals such as a resource block comb approach 800 in which resource blocks 802 can be either occupied by reference signals or not across the different antenna ports 804. The framework can represent a uniform or non-uniform pattern. In one aspect, the approach reduces the density of the use of the frequency domain by only having data in certain frequencies with other frequencies not having any reference signals such as in the resource block comb approach 800. In another aspect, the pattern can be a random selection 810 of the antenna port 814 and resource block (RB) or resource element (RE) 812. In each RB, the approach is to select a few antennas to track the CSI-RS. In one aspect, there can be Nt ports multiplexed on L number of REs per RB via a learned cover-code 820. The cover-code can multiplex the Nt port on L REs per RB. In some cases, Nt can be 32 where L can be 8 or 4. In other aspect, Nt can be a high value (e.g., 1024) and L can be a low value (e.g., 32 or 16).

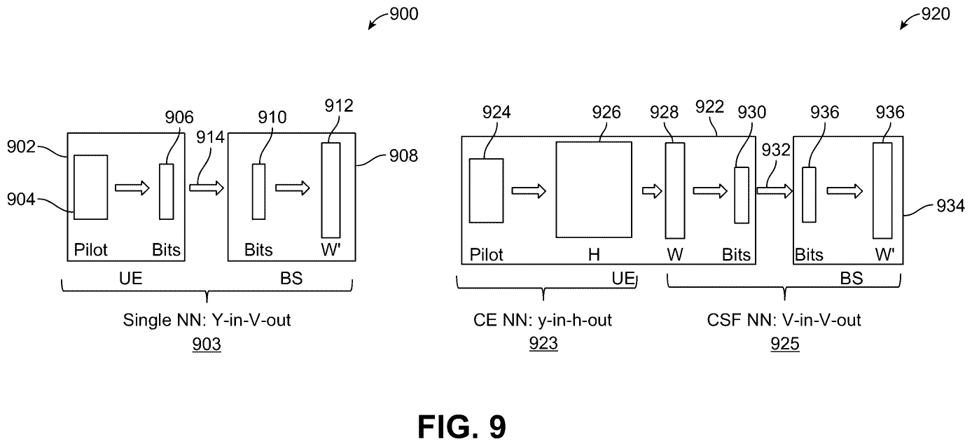

FIG. 9 is a diagram 920 illustrates another aspect of this disclosure in which channel state feedback under low density CSI-RS can be implemented in several ways. Normally, for CSI-RS and CSI feedback, there are two functions. One function is to perform channel estimation taking the CSI-RS signal as input. A second function is to take the channel estimation as input and compress the channel estimation into a latent message and then report the latent message as the CSI-feedback. The machine learning models that perform these different functions are normally designed and trained separately. The diagram 920 shown in FIG. 9 illustrates an approach with separate networks. Under a low-density CSI-RS, when there are two separate functions as described above, errors can propagate through the system. The system will determine whether to jointly perform channel estimation and CSI feedback. A single neural network can provide more directly the CSI-feedback that is based on the inputs, which can reduce the possibility of introducing errors. Model 900 in FIG. 9 illustrates the use of a combined single neural network.

In one example, a combination machine learning model 900 of a UE 902 and a base station 908 implements a single neural network (NN) which jointly perform the two different functions described above related to channel estimation. In one aspect, at the UE side, the UE 902 uses the CSI-RS received signal as the input 904 to the NN 903, and the output is the latent message 906. In some cases, the latent message is quantized into sequence of bits, referred to as latency bits 906. The latency bits 906 can be provided (e.g., transmitted) as a latent message 914 to the base station 908, where the bits of the received latent message 914 are represented by bits 910. At the base station 908, the NN 903 reconstructs the CSI (shown as data W′ 912) from the bits 910 of the received latent message 914. The Y input (e.g., the CSI-RS) and the output data V or W′ 912 can be the output or CSI for all ports and all the frequency resources.

Neural networks are shown in the diagram 920 of FIG. 9 representing an approach in which there are two separate functions or machine learning models across the UE 922 and the base station 934. A first portion or model includes a channel estimation neural network 923 and a second portion or model includes a channel state feedback neural network 925. In one aspect, an input 924 is received at the UE 922 and the channel estimation neural network 923 receives the Y input data and produces H data 926, which as noted above can be a channel matrix. The UE 922 generates W data 928 from the H data 926 via singular value decomposition (SVD) 929. Spanning part of the UE 922 and the base station 934, the channel state feedback neural network 923 can receive W as shown in FIG. 9 (which can be denoted as V in some cases) as input and generate latency bits 930 or the latent message as the reconstructed eigen vector. The latency bits 930 or the latent message are transmitted 932 to the base station 934 and represented as input bits 936 representing the CSI for all the channel resources. The channel state feedback neural network 923 (e.g., a decoder of a neural network) processes the bits 936 and reconstructs the CSI 936 (denoted as W′), which can then be output by the channel state feedback neural network 923. The approach shown in the diagram 920 can cause the channel estimation process to be a bottleneck and limit the performance of the system. Whether the UE should report CSI for some of the resource blocks and/or subband resources or report the CSI for all the resources is the focus of this disclosure. The issue is whether for all resources the UE can recover the channel for the full resources and compress the data again. As noted above, some resources may have bad channel estimation quality and thus provide no benefit for the CSI report.

As also previously noted, systems and techniques are described herein for providing a machine learning approach to channel state feedback that removes the bottleneck experienced by using two separate neural networks for channel state feedback, as shown in the diagram 920 of FIG. 9. The systems and techniques can also apply to other types of control information other than CSI.

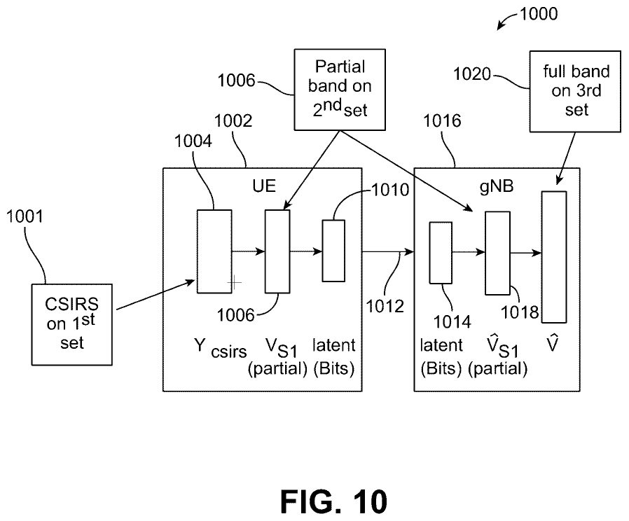

FIG. 10 illustrates the process of generating channel state information from CSI-RS. The process 1000 shown uses a single NN across the UE 1002 and the gNB or base station 1016. From the UE 1002 perspective, the solution includes receiving a CSI-RS 1001 transmission on a first set of frequency units (e.g., RB or subbands) as a partial set of the total frequency units and/or a first set of antenna ports out of a total number of antenna ports. The first set of frequency units can include down-sampled CSI-RS (in RB-comb fashion, or non-uniform RB pattern as shown in FIG. 8). The feature Y_{CSIRS} 1004 represents the reception at the UE 1002 of the CSI-RS 1001.

The UE 1002 can generate, via a NN block 1006 and based on Y_{CSIRS}, a CSI (as an intermediate output) for a second set of frequency units and/or a second set of antenna ports Vₛ₁ 1008 to facilitate CSI generation or reconstruction on a third set of frequency units and/or a third set of antenna ports. Then, a latent message 1010 can be generated from Vₛ₁ and reported to the gNB or base station 1016. In one aspect, a latent message 1010 can be generated and quantized to bits directly from the Y_{CSIR} value and transmitted 1012 to the gNB or base station 1016. The second set of frequency units and/or the second set of antenna ports can be determined based at least in part on at least one of the first set of frequency units and/or the first set of antenna ports, the third set of frequency units and/or the third set of antenna ports, a received signal power, an interference level, a channel estimation accuracy of the received CSI-RS, or based on a gNB configuration.

The gNB or base station 1016 receives the latent bits 1014 and generates, via a NN block, the CSI feedback for the second set of frequency units and/or a second set of antenna ports V′ₛ₁ 1018 from which a last block of the NN generates or reconstructs the CSI (V′) for the third set of frequency units and/or a third set of antenna ports 1020. V′ represents the estimate of the full CSI for all the resources. The third set of frequency units and/or the third set of antenna ports in one aspect covers the full resources and ports. In another aspect, the third set of frequency units and/or the third set of antenna ports can be configured in advance or dynamically by the network or alternatively can be dependent at least in part on the second set of frequency units and/or the second set of antenna ports. The UE 1002 transmits the CSI report to the base station 1016.

Different options can be used to structure or select one or more of the first set of frequency units and antenna ports and the second set of frequency units and antenna ports. In one example, the second set of frequency units or the second set of antenna ports can be chosen based at least in part on at least one of the first set of frequency units or the first set of antenna ports, at least one of the third set of frequency units or the third set of antenna ports, a received signal power, an interference level, a channel estimation accuracy of the CSI reference signal, or based on configuration information received from the base station. Typically, the third set of frequency units or third set of antenna ports are the full set of resources.

There can be a relationship between the first set of frequency units and/or the first set of antenna ports and other sets as well. In a first option, the second set of frequency units can equal the first set of frequency units, or the second set of frequency units can represent the subband with at least one RB containing the CSI-RS. For example, a frequency density can equal 0.125 and the CSI-RS can be configured on RBs {7, 15, 23, 31, 39, 47} of a total of 48 RBs corresponding to subbands {1, 3, 5, 7, 9, 11} considering a subband size is equal 4 RBs. In one aspect, in every two subbands there will be a CSI report. Note that in one example, RBs that are “close” to chosen RBs for transmitting the CSI-RS ({7, 15, 23, 31, 39, 47}), such as RB 16, 32, 40 and so forth, can be considered of good quality as well, and therefore the reported subband may include subband {1, 3, 4, 5, 7, 8, 9, 10, 11}.

In another option, the second set of frequency units can equal the first set of frequency units plus additional frequency units, where the additional units are configured by the network or determined based on pre-defined rules. For example, the CSI-RS can be configured on RBs {7, 15, 23, 31, 39, 47} (and they correspond to subband {1, 3, 5, 7, 9, 11}) where edge subbands {0, 11} are always selected and on a second set of subbands {0, 1, 3, 5, 7, 9, 11} even though subband 0 does not contain any CSI-RS in one aspect. Different patterns can be used which can vary the number of subbands used and whether the number includes one or more edge subbands. The average squared generalized cosine similarity (SGCS) can be used to evaluate the CSI compression and reconstruction accuracy. The SGCS value can go up or down depending on the number of SBs chosen, and in some cases depending on whether edge subbands are chosen.

Another option can include where the second set of frequency units are on the subband with a high channel estimation (CE) quality across RBs/subbands as determined by the UE 1002. In one aspect, the UE 1002 can report the selection of the second set of frequency units based on the high CE quality. In one example, a high CE quality can be determined by one or more of a high reference signal received power (RSRP), or interference measurement level, or signal to interference plus noise ratio (i.e., SINR) or a location of a respective RB or subband being close to the CSI-RS. In such a case, the RB or subband being close to the CSI-RS may have a high CE quality.

In some cases, depending on the structure of the channel, different subband numbers can give a good CE quality for the channel. For example, there can be different patterns and different uses of the subbands. In one case, the pattern may include edges subbands and can include a total of six subbands. The chosen subbands can be: {0, 2, 4, 7, 9, 11}. In another example, the patterns can include edge subbands and a total of eight subbands and thus can include: {0, 2, 3, 4, 7, 8, 9, 11}. Another pattern can include an edge subband and a total of ten subbands with a pattern as follows: {0, 1, 2, 3, 4, 7, 8, 9, 10, 11}. Another example of a pattern can include all 12 subbands.

In another aspect, the process can include generating CSI feedback for the second set of frequency units and/or the second set of antenna ports to facilitate the CSI generation or reconstruction on a third set of frequency units and/or a third set of antenna ports.

From the perspective of the gNB or base station 1016, the machine learning channel state feedback under low density approach can include the gNB or base station 1016 transmitting the CSI-RS on the first set of frequency units and/or the first set of antenna ports. The gNB or base station 1016 receives the CSI feedback for the second set of frequency units and/or the second set of antenna ports. The gNB or base station 1016 can generate a final CSI V′ for the third set of frequency units and/or the third set of antenna ports. In one aspect, the third set of frequency units and/or the third set of antenna ports represents the total frequency resource (e.g., full subbands of the bandwidth parts (BWP)) and all antenna ports. Alternatively, third set of frequency units and/or the third set of antenna ports is dependent at least in part on the second set and may represent less than the total frequency resource.

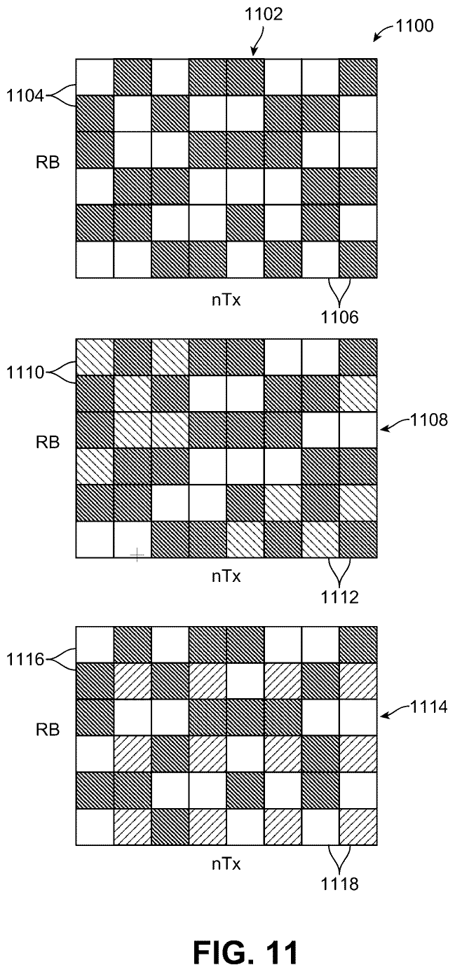

FIG. 11 illustrates a set of optional approaches 1100 for determining frequency units and antenna ports related to generating channel state information. In a first example, a first set of frequency units 1102 and antenna ports 1106 can be chosen by the base station via Tx-RB selection on which CSI-RS is transmitted. For example, on each resource block (RB) 1104, the CSI-RS may only be transmitted via a specifically selected antenna ports 1106. The filled-in blocks represent a respective RB on a respective antenna port used for transmitting the CSI-RS. In one aspect, the second set of frequency units and antenna ports can equal the first set of frequency units and antenna ports. In other words, on each RB 1104, only the CSI for the transmitted ports is generated and reported.

In another example, the second set of frequency units 1108 and antenna ports 1112 can equal the first set of frequency units and antenna ports plus additional ports on each RB 1110. The additional ports can be pre-defined, or configured by the network, or reported by the UE. One shading of the ports shown in matrix or the second set of frequency units 1108 can represent the first set of frequency units and antenna ports and the other shading can represent the additional ports. Both sets of ports are reported.

In another example, the third set of frequency units 1114 and antenna ports 1118 can equal the full set of ports or selected ports (but these ports are common for all selected RBs 1116) plus other selected RBs. In one example, the selected RBs and ports can be pre-defined, or configured by network or reported by UE. The shading in FIG. 11 associated with ports 1118 can represent the ports that are reported even though there is no CSI-RS on a port of an RB. In one aspect, when the CSI-RS is reported by the UE, the UE determines it based on channel estimation quality.

In one aspect related to signaling or providing information about the sets of frequency units and antenna ports, the first set of frequency units and antenna ports can be configured via a CSI-RS resource pattern. In another aspect, the third set of frequency units and antenna ports can be configured by a CSI report related to a subband configuration and number of antenna ports in the CSI report configuration. In another aspect, the third set of frequency units and antenna ports can be derived from the second set of frequency units and antenna ports. The second set frequency units and antenna ports can be either, pre-defined, configured via dedicated signaling (radio resource control (RRC) or MAC control element (MACCE)), or reported by the UE in the uplink control information (UCI) together with the CSI report.

In some cases, the first set of frequency units and the first set of antenna ports are selected by the base station and/or determined by the UE, such as using the following techniques. For instance, the base station can select the first set of frequency units and the first set of antenna ports using one or more of the following techniques. The UE can be made aware of how the first set of frequency units and the first set of antenna ports are selected (e.g., based on the techniques or rules being specified in a Standard, such as the 3GPP Standard). In one example, the base station can partition the frequency units into groups, where consecutive 2N RBs are considered in the same group (e.g., with N=1,2, etc). For the first half of the RBs in each group, the base station can determine or select L ports out of the total Nt ports. For the second half RBs in each group, the base station can determine or select another L ports out of the Nt-L ports other the L ports selected for the first half of RBs. For example, if L=4 and Nt=32, port {0, 5, 19, 28} are selected for the first half RBs, and then another 4 ports are selected from the complementary set, i.e., {1, 2, 3, 4, 6, 7, 8, 9, 10, 11, 12, 13, 14, 15, 16, 17, 18, 20, 21, 22, 23, 24, 25, 26, 27, 29, 30, 31}, for the second half of RBs. A possible result for the second half of RBs can be port {9, 14, 24, 31}. In one illustrative example, to select L ports for each half of the RBs, the base station can select the L ports based on a random selection with a seed determined by cell ID, BWP ID or UE ID. In another illustrative example, the base station can select L ports for each half of the RBs by always selecting the first available L indices. An illustrative example of an algorithm is shown below, where N_{f} is the total number of RBs, and B is the number of RBs with CSI-RS presence, C denotes the total port indices (here we assume the index starting from 1 to Nt), And Ω_{b}, b=1, . . . , B denotes the set of ports selected for b-th RB with CSI-RS presence. Moreover, N can be set to 1 (N=1), meaning that every two RBs belong to one group.

Algorithm 1 Frequency-aware Antenna Selection Pattern

| | |
|---|---|
| 1: | Input: a = L/Nₜ. B = aN_{f}. and [symbol] = {1.2.....Nₜ} |
| 2: | Output: The generated patterns Ω₁.Ω₂.....Ω_{B} |
| 3: | Initialization: b ← 1 |
| 4: | while b ≤ B do |
| 5: | k ← 1.Ω_{b} ← Ø and Ω′_{b} ← [symbol] |
| 6: | while k ≤ 1/a do |
| 7: | Generate Ω_{b.k} by randomly selecting L indices from |
| | the set Ω′_{b} |
| 8: | Ω_{b} ← Ω_{b} ∪ Ω_{b.k} |
| 9: | Ω′_{b} ← [symbol] \ Ω_{b} |
| 10: | k ← k + 1 |
| 11: | end while |
| 12: | b ← b + 1 |
| 13: | end while |

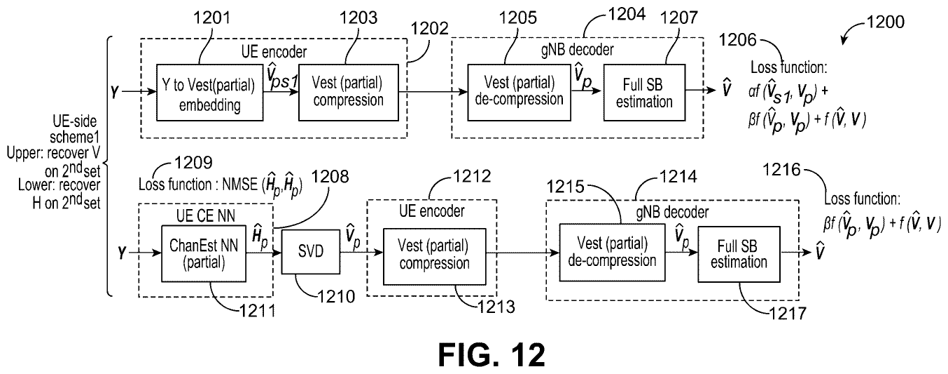

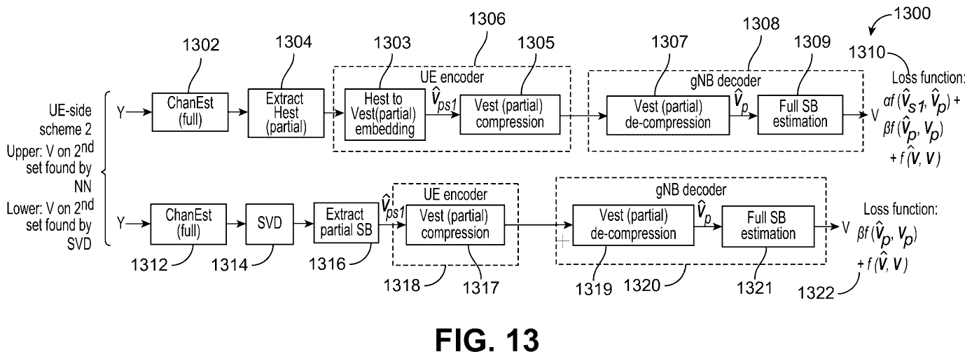

FIG. 12 is a block diagram 1200 illustrating encoder and decoder functions related to generating channel state information. The machine learning model shown in the process 1000 of FIG. 10 that spans the UE 1002 and the base station 1016 can be designed and trained in various ways as is illustrated in FIGS. 12 and 13. As shown in FIG. 12, the UE-side model on the UE encoder 1202 can be trained for example in a first aspect related to partial subband recovery and compression. A first transformer module 1201 (which can be either an artificial intelligence/machine learning model (AI/ML) or a non-AI/ML model) can be used to generate the CSI which in one aspect is V′p or a precoder value of the second set of frequency units and antenna ports with the input Y being the CSI-RS on the first set of frequency units and antenna ports. A second transformer module 1203 (AI model) can be used to compress the CSI on the second set of frequency units to latent space.

The gNB decoder 1204 can include its portion of the ML model. The portion of the model can be designed and trained in various ways. In one aspect, a first module 1205 (AI/ML model) can be used to reconstruct the CSI on the second set of frequency units and antenna ports plus a second module 1207 (AI/ML model) can be used to generate the CSI on the full set of frequency units and antenna ports taking the second set as inputs. The first aspect shown in FIG. 12 recovers V′p′ (the downlink precoders) on the second set of frequency units and antenna ports.

As discussed above with respect to FIG. 5 and the training process for machine learning models, the loss functions disclosed in FIGS. 12 and 13 are used to determine what values to backpropagate through the networks during training. The loss function 1206 for the AI/ML model can relate to a weighted sum of at least two of: the loss between third set CSI (e.g., the final output at the gNB decoder 1204) and its ground-truth (V); the loss between the second set of CSI (i.e., the output of the first transformer module 1201) generated at UE encoder 1202 (V′p) and its ground-truth (Vₚ); and the loss between a reconstructed second set of CSI (i.e., the output V′_{p′} of the first module 1205 at the gNB decoder 1204) and its ground-truth (Vₚ). In these values, “p” represents a partial subband.

FIG. 12 also shows, on a UE 1208, a UE channel estimation neural network 1211 that generates an output H′ₚ matrix which is processed by singular value decomposition 1210 into precoder values V′ₚ which values are provided to the UE encoder 1212. A module 1213 (AI model) can be used to compress the V′ₚ on the second set of frequency units and antenna ports to latent space. A loss function 1209 is shown the normalized mean square error (NMSE) (H′ₚ, Hₚ). The gNB decoder 1214 can include a first module 1215 (AI/ML model) that can be used to reconstruct the V′_{p′} (the CSI on the second set of resources) and a second module 1217 (AI/ML model) that can be used to generate the CSI on the full set of frequency units and antenna ports (V′) or in one aspect recover the H (the downlink channel matrix) on the second set of frequency units or antenna ports. A loss function 1216 is also shown in FIG. 12 for one aspect.

In another aspect, a single module can be used to reconstruct the CSI of the full set of frequency units and antenna ports. FIG. 13 is a block diagram illustrating encoder and decoder functions 1300 related to generating channel state information. The top portion of FIG. 13 relates to full subband recovery and extraction. In one aspect, a first module 1302 (either AI/ML model or a non-AI/ML model) can be used to recover the channel or precoder on full subbands and ports, with the input Y being the CSI-RS on the first set of frequency units and antenna ports. A second module 1304 can be used to extract the CSI (downlink channel matrix H estimate or Hₑₛₜ) on the second set of frequency units and antenna ports from the full set. A third module 1303 (of a UE encoder 1306) can be used to generate precoder on the second set of frequency units and/or antenna ports taking the channel estimate on the second set of frequency units and/or antenna ports as input. The output of the third module 1303 can be V′ₚ and its ground-truth (Vₚ). A fourth module 1305 (of the UE encoder 1306), which in some cases can be a machine learning or AI model (e.g., a neural network model) can be used to compress the CSI (or output V′ₚ) of the third module 1303 on the second set of frequency units and antenna ports to the latent space. The first module 1302 at the UE can be jointly trained with other modules or separately trained.

At the gNB decoder 1308, a first module 1307 can perform de-compression of received latent message and provides V′_{p′} to a second module 1309 that performs a full subband estimation and output V. An example loss function 1310 is shown in FIG. 13 for one aspect.

FIG. 13 also shows another aspect in which the V on the second set of frequency units and antenna ports is found by singular value decomposition. In one aspect, a first module 1312 performs full channel estimation on the Y input and a second module 1314 performs singular value decomposition (SVD) and from its output a third module 1316 extracts partial subband V′ₚ which are then compressed into latent space by a fourth module 1317 on the UE encoder 1318. The gNB decoder 1320 performs via a first module 1319 de-compression to generate V′ₚ and performs via a second module 1321 a full subband estimation to generate V. A loss function 1322 is shown by way of example in FIG. 13.

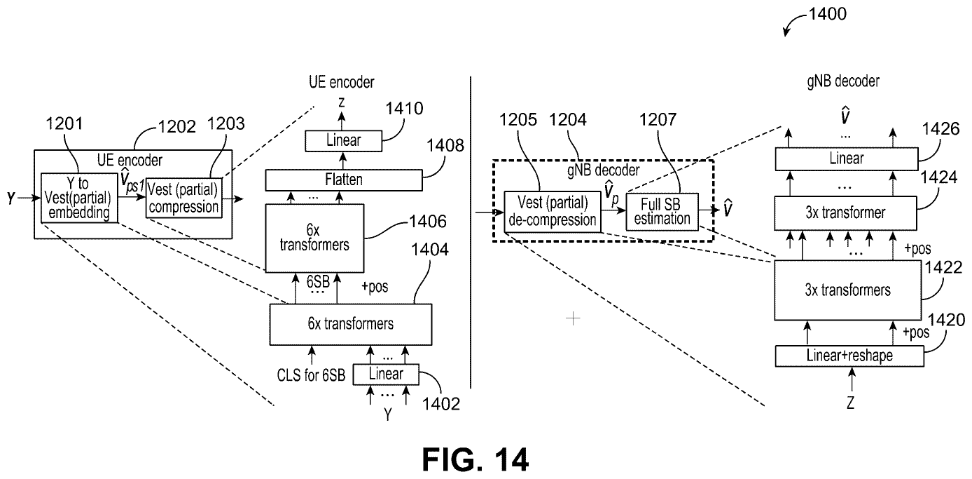

FIG. 14 is a diagram 1400 illustrating further encoder and decoder functions related to generating channel state information. The UE encoder 1202 of FIG. 12 is shown in more detail. The first transformer module 1201 can recover the partial CSI with a corresponding CLS (classification) token. The CLS token corresponds to a subband in the second set. The Y input can be processed at a linear layer 1402 and its output is provided to the second transformer module 1203 which includes a 6× transformer blocks 1404 to generate the CSI for the second set of frequency units (6 subbands in one aspect). The second transformer module 1203 compresses the CSI with corresponding positional embeddings to store the location of the reported subband. Positional (pos) information is added to the output of 1404 to memorize the positional information of the second set of frequency units out of the full frequency units. After that, the positional embedded output is passed to the transformer layer 1406 which output is provided to a flattening layer 1408 which output is provided to a linear layer or singular value decomposition 1410 to generate the Z output. A transformer in one example is a deep learning model that adopts the mechanism of self-attention and differentially weights the significance of each part of the input data. However, unlike recurrent neural networks (RNNs), transformers process the entire input all at once. The attention mechanism provides context for any position in the input sequence. For example, if the input data is a natural language sentence, the transformer does not have to process one word at a time. The approach allows for more parallelization than RNNs and therefore reduces training times. While these modules are described as transformer-based neural networks, other types of neural networks can be implemented as well. The example shown in FIG. 14 uses 6 TF blocks in first module and 6 TF in second module, other number of TF blocks can be considered in other examples.

The gNB decoder 1204 includes the first transformer module 1205 that includes a linear plus a reshaping layer 1420. Then positional information is added and provides its output to a 3× transformer layer as a second transformer layer 1422 which recovers the CSI on partial subbands (for example, 6 subbands). The first transformer module 1205 recovers the CSI on a partial subband (e.g., such as 6 subbands out of 12 subbands). The positional embedding is added to record the respective location of the subbands and then can interpolate to 12 subbands with the position embedding of all 12 subbands in the second TF module. The second transformer module 1207 includes a 3× transformer layer as a first transformer layer 1424 and a linear layer 1426 that interpolates those values to 12 subbands with a positional embedding of all 12 subbands including padding needed to pad from 6 subband to 12 subbands. The output is V′ which represents the CSI for all the resources. The positional embedding in both the first transformer layer 1424 and the second transformer layer 1422 are used to store the location of the second set of the respective set of subbands which represent the partial set of all the resources. The number of subbands described above is exemplary only and other numbers of subbands can be used as well. The example shown in FIG. 14 uses 3 transformer blocks in first transformer layer 1424 and 3 transformer blocks in second transformer layer 1422, other number of transformer blocks can be considered in other examples.

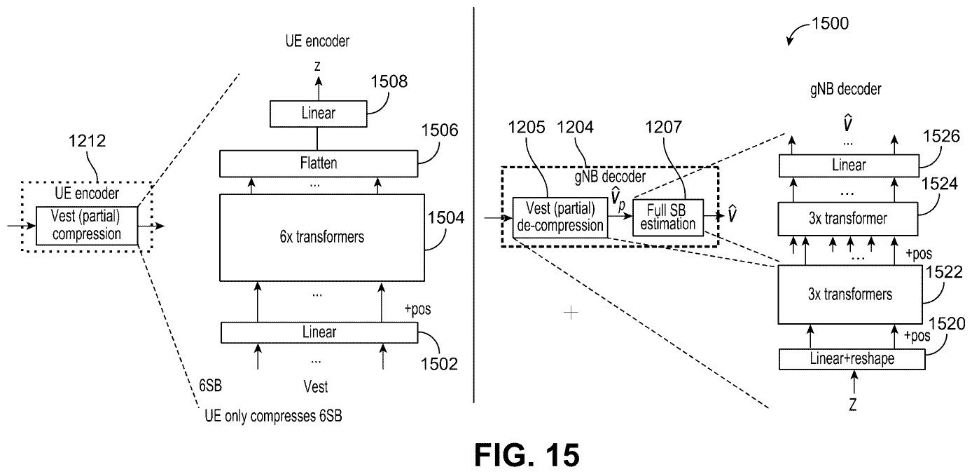

FIG. 15 is a diagram 1500 illustrating further encoder and decoder functions related to generating channel state information. The diagram 1500 illustrates a transformer-based neural network that compresses the partial subband CSI (V estimate) with corresponding positional embedded data to store the location of the reported subband. The UE encoder 1212 can include a compression module 1213 that compresses the V estimation (Vest). The compression module 1213 can process the Vest through a linear layer 1502 to provide the positional embeddings representing the location of the subbands of the second set which is then processed by a 6× transformer 1504, which output is processed by a flattening layer 1506, which output is processed by a linear layer 1508 to produce a Z output. The gNB decoder in the figure can be the same as the gNB decoder shown in FIG. 14.

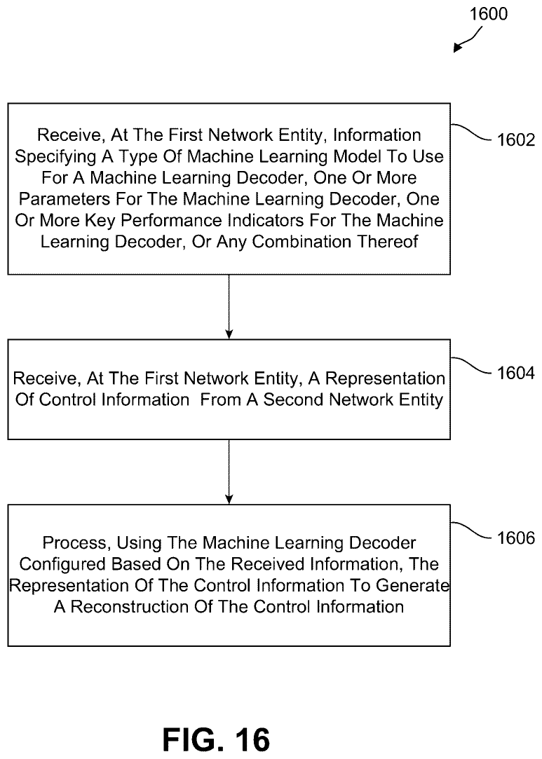

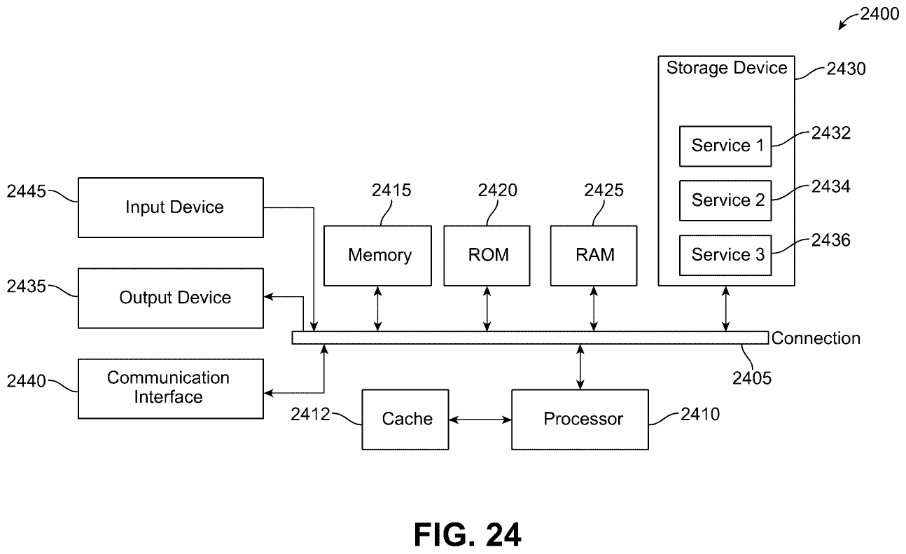

FIG. 16 is a flowchart of an example process 1600 for providing wireless communications at a user equipment (UE). The process 1600 can be performed by a UE (e.g., the UE 751 of FIG. 7 or UE 1002 of FIG. 10) or other component or system of the UE or of any device. The operations of the process 1600 may be implemented as software components that are executed and run on one or more processors (e.g., a processor 2410 of FIG. 24 or other processor(s)). Further, the transmission and reception of signals by the UE in the process 1600 may be enabled, for example, by one or more antennas and/or one or more transceivers (e.g., wireless transceiver(s)).

At block 1602, the process 1600 can include receiving (e.g., by the UE 751 of FIG. 7 or UE 1002 of FIG. 10), from a base station (or component thereof), a channel state information (CSI) reference signal (e.g., CSI-RS 1001 of FIG. 10) on at least one of a first set of frequency units or a first set of antenna ports. In one aspect, at least one of the first set of frequency units or the first set of antenna ports includes at least one of less than all available frequency units or less than all available antenna ports. In some aspects, receiving the CSI reference signal further can include receiving the CSI reference signal on the first set of frequency units and via the first set of antenna ports.

At block 1604, the process 1600 can include generating (e.g., by the UE 751 of FIG. 7 or UE 1002 of FIG. 10) CSI based on the CSI reference signal.

At block 1606, the process 1600 can include transmitting (e.g., by the UE 751 of FIG. 7 or UE 1002 of FIG. 10), from the UE to the base station, information associated with the CSI on at least one of a second set of frequency units or a second set of antenna ports for use in reconstructing (e.g., by the base station 753 of FIG. 7 or gNB or base station 1016 of FIG. 10) the CSI on at least one of a third set of frequency units or a third set of antenna ports, wherein at least one of the second set of frequency units or the second set of antenna ports includes at least one of less than all available frequency units or less than all available antenna ports. In some aspects, the first set of frequency units and the second set of frequency units are a same set of frequency units.

In some aspects, the techniques described herein relate to a method, wherein at least one of the second set of frequency units or the second set of antenna ports is determined based at least in part on at least one of the first set of frequency units or the first set of antenna ports, at least one of the third set of frequency units or the third set of antenna ports, a received signal power, an interference level, a channel estimation accuracy of the CSI reference signal, or based on configuration information received from the base station.

In some aspects, the third set of frequency units can include all available frequency units and the third set of antenna ports includes all available antenna ports. In some aspects, transmitting the information associated with the CSI can include transmitting the information associated with the CSI on the second set of frequency units and using the second set of antenna ports. In some aspects, the second set of frequency units can include a subband with at least one resource block containing the CSI reference signal.

In some aspects, the second set of frequency units can include the first set of frequency units and at least one additional frequency unit. The at least one additional frequency unit can be configured by a network or determined based on pre-defined rules. The second set of frequency units can be in a subband associated with a high channel estimation quality across at least one of a set of resource blocks or a set of subbands. The high channel estimation quality can be determined by one or more of a high reference signal received power, or interference and/or noise measurement, or a resource block/subband close to the CSI reference signal.

In some aspects, the first set of frequency units and the first set of antenna ports can be the same as the second set of frequency units and the second set of antenna ports.

In some aspects, the second set of frequency units and the second set of antenna ports can include the first set of frequency units and the first set of antenna ports and at least one additional antenna port. The at least one additional antenna port may be one of pre-defined, based on configuration information received from the base station, or reported by the user equipment.

The second set of antenna ports may include all available antenna ports or a selected set of antenna ports. In some aspects, the second set of antenna ports can include the selected set of antenna ports, and the selected set of antenna ports can be pre-defined or are based on configuration information received from the base station.

In some aspects, the first set of frequency units, the second set of frequency units, and the third set of frequency units are different sets of frequency units. In other aspects, the first set of antenna ports, the second set of antenna ports, and the third set of frequency units are different sets of antenna ports. The third set of frequency units may include all available frequency units.

In some aspects, at least the first set of frequency units or the first set of antenna ports can be configured based on a resource pattern of the CSI reference signal.

In some aspects, at least the third set of frequency units or the third set of antenna ports is at least one of configured based on a CSI reporting subband configuration or is dependent on at least one of the second set of frequency units or the second set of antenna ports.

In some aspects, at least the second set of frequency units or the second set of antenna ports can be at least one of pre-defined, based on configuration information received from the base station, or transmitted in a CSI report including the information associated with the CSI.

In some aspects, the information associated with CSI includes a latent representation of the CSI generated using a machine learning encoder.

In some aspects, the techniques described herein relate to an apparatus (e.g., such as UE 751 of FIG. 7 or UE 1002 of FIG. 10) for wireless communication, the apparatus including: at least one memory; and at least one processor coupled to the at least one memory and configured to: receive, from a base station (e.g., such as the base station 753 of FIG. 7 or gNB or base station 1016 of FIG. 10), a channel state information (CSI) reference signal on at least one of a first set of frequency units or a first set of antenna ports, wherein at least one of the first set of frequency units or the first set of antenna ports includes at least one of less than all available frequency units or less than all available antenna ports; generate CSI based on the CSI reference signal; and transmit, to the base station, information associated with the CSI on at least one of a second set of frequency units or a second set of antenna ports for use in reconstructing the CSI on at least one of a third set of frequency units or a third set of antenna ports, wherein at least one of the second set of frequency units or the second set of antenna ports includes at least one of less than all available frequency units or less than all available antenna ports.

In some aspects, the techniques described herein relate to an apparatus (e.g., such as UE 751 of FIG. 7 or UE 1002 of FIG. 10), wherein at least one of the second set of frequency units or the second set of antenna ports is determined based at least in part on at least one of the first set of frequency units or the first set of antenna ports, at least one of the third set of frequency units or the third set of antenna ports, a received signal power, an interference level, a channel estimation accuracy of the CSI reference signal, or based on configuration information received from the base station.

In some aspects, the techniques described herein relate to an apparatus (e.g., such as UE 751 of FIG. 7 or UE 1002 of FIG. 10), wherein the third set of frequency units includes all available frequency units and the third set of antenna ports includes all available antenna ports.

In some aspects, the techniques described herein relate to an apparatus (e.g., such as UE 751 of FIG. 7 or UE 1002 of FIG. 10), wherein receiving the CSI reference signal further includes receiving the CSI reference signal on the first set of frequency units and via the first set of antenna ports.

In some aspects, the techniques described herein relate to an apparatus (e.g., such as UE 751 of FIG. 7 or UE 1002 of FIG. 10), wherein transmitting the information associated with the CSI includes transmitting the information associated with the CSI on the second set of frequency units and using the second set of antenna ports.

In some aspects, the techniques described herein relate to an apparatus (e.g., such as UE 751 of FIG. 7 or UE 1002 of FIG. 10), wherein the first set of frequency units and the second set of frequency units are a same set of frequency units.

In some aspects, the techniques described herein relate to an apparatus (e.g., such as UE 751 of FIG. 7 or UE 1002 of FIG. 10), wherein the second set of frequency units include a subband with at least one resource block containing the CSI reference signal.

In some aspects, the techniques described herein relate to an apparatus (e.g., such as UE 751 of FIG. 7 or UE 1002 of FIG. 10), wherein the second set of frequency units includes the first set of frequency units and at least one additional frequency unit.

In some aspects, the techniques described herein relate to an apparatus (e.g., such as UE 751 of FIG. 7 or UE 1002 of FIG. 10), wherein the at least one additional frequency unit is configured by a network or determined based on pre-defined rules.

In some aspects, the techniques described herein relate to an apparatus, wherein the second set of frequency units are in a subband associated with a high channel estimation quality across at least one of a set of resource blocks or a set of subbands.

In some aspects, the techniques described herein relate to an apparatus (e.g., such as UE 751 of FIG. 7 or UE 1002 of FIG. 10), wherein the high channel estimation quality is determined by one or more of a high reference signal received power, or interference and/or noise measurement, or a resource block/subband close to the CSI reference signal.

In some aspects, the techniques described herein relate to an apparatus (e.g., such as UE 751 of FIG. 7 or UE 1002 of FIG. 10), wherein the first set of frequency units and the first set of antenna ports are the same as the second set of frequency units and the second set of antenna ports.

In some aspects, the techniques described herein relate to an apparatus (e.g., such as UE 751 of FIG. 7 or UE 1002 of FIG. 10), wherein the second set of frequency units and the second set of antenna ports includes the first set of frequency units and the first set of antenna ports and at least one additional antenna port.

In some aspects, the techniques described herein relate to an apparatus (e.g., such as UE 751 of FIG. 7 or UE 1002 of FIG. 10), wherein the at least one additional antenna port is one of pre-defined, based on configuration information received from the base station, or reported by the user equipment.

In some aspects, the techniques described herein relate to an apparatus (e.g., such as UE 751 of FIG. 7 or UE 1002 of FIG. 10), wherein the second set of antenna ports includes all available antenna ports or a selected set of antenna ports.

In some aspects, the techniques described herein relate to an apparatus (e.g., such as UE 751 of FIG. 7 or UE 1002 of FIG. 10), wherein the second set of antenna ports includes the selected set of antenna ports, and wherein the selected set of antenna ports are pre-defined or are based on configuration information received from the base station.

In some aspects, the techniques described herein relate to an apparatus (e.g., such as UE 751 of FIG. 7 or UE 1002 of FIG. 10), wherein the first set of frequency units, the second set of frequency units, and the third set of frequency units are different sets of frequency units.

In some aspects, the techniques described herein relate to an apparatus (e.g., such as UE 751 of FIG. 7 or UE 1002 of FIG. 10), wherein the first set of antenna ports, the second set of antenna ports, and the third set of frequency units are different sets of antenna ports.

In some aspects, the techniques described herein relate to an apparatus (e.g., such as UE 751 of FIG. 7 or UE 1002 of FIG. 10), wherein the third set of frequency units include all available frequency units.

In some aspects, the techniques described herein relate to an apparatus (e.g., such as UE 751 of FIG. 7 or UE 1002 of FIG. 10), wherein at least the first set of frequency units or the first set of antenna ports is configured based on a resource pattern of the CSI reference signal.

In some aspects, the techniques described herein relate to an apparatus (e.g., such as UE 751 of FIG. 7 or UE 1002 of FIG. 10), wherein at least the third set of frequency units or the third set of antenna ports is at least one of configured based on a CSI reporting subband configuration or is dependent on at least one of the second set of frequency units or the second set of antenna ports.

In some aspects, the techniques described herein relate to an apparatus (e.g., such as UE 751 of FIG. 7 or UE 1002 of FIG. 10), wherein at least the second set of frequency units or the second set of antenna ports is at least one of pre-defined, based on configuration information received from the base station, or transmitted in a CSI report including the information associated with the CSI.

In some aspects, the techniques described herein relate to an apparatus (e.g., such as UE 751 of FIG. 7 or UE 1002 of FIG. 10), wherein the information associated with CSI includes a latent representation of the CSI generated using a machine learning encoder.

In some aspects, the techniques described herein relate to a non-transitory computer-readable storage medium (e.g., such as memory 2415 of FIG. 24) including instructions stored thereon which, when executed by at least one processor, causes the at least one processor to: receive, from a base station (e.g., such as base station 753 of FIG. 7 or gNB or base station 1016 of FIG. 10), a channel state information (CSI) reference signal on at least one of a first set of frequency units or a first set of antenna ports, wherein at least one of the first set of frequency units or the first set of antenna ports includes at least one of less than all available frequency units or less than all available antenna ports; generate CSI based on the CSI reference signal; and transmit, to the base station, information associated with the CSI on at least one of a second set of frequency units or a second set of antenna ports for use in reconstructing the CSI on at least one of a third set of frequency units or a third set of antenna ports, wherein at least one of the second set of frequency units or the second set of antenna ports includes at least one of less than all available frequency units or less than all available antenna ports.

In some aspects, the techniques described herein relate to an apparatus (e.g., such as base station 753 of FIG. 7 or gNB or base station 1016 of FIG. 10) for wireless communications including one or more means to perform operations including: receiving, from a base station, a channel state information (CSI) reference signal on at least one of a first set of frequency units or a first set of antenna ports, wherein at least one of the first set of frequency units or the first set of antenna ports includes at least one of less than all available frequency units or less than all available antenna ports; generating CSI based on the CSI reference signal; and transmitting, to the base station, information associated with the CSI on at least one of a second set of frequency units or a second set of antenna ports for use in reconstructing the CSI on at least one of a third set of frequency units or a third set of antenna ports, wherein at least one of the second set of frequency units or the second set of antenna ports includes at least one of less than all available frequency units or less than all available antenna ports.

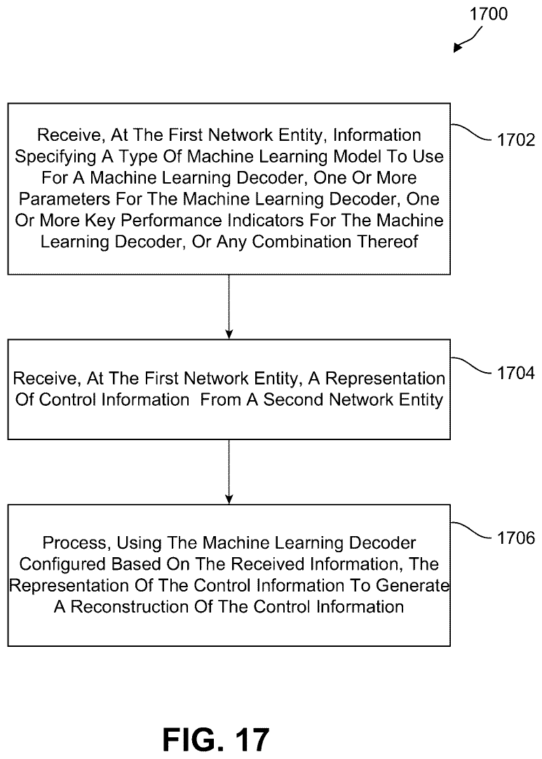

FIG. 17 is a flow diagram illustrating an example of a method or process 1700 for wireless communication from the standpoint of a base station (e.g., by the base station 753 of FIG. 7 or gNB or base station 1016 of FIG. 10). The process 1700 can be performed by a base station, gNB, or by a component or system of any device. The operations of the process 1700 may be implemented as software components that are executed and run on one or more processors (e.g., processor 2410 of FIG. 24 or other processor(s)). Further, the transmission and reception of signals by the UE in the process 1700 may be enabled, for example, by one or more antennas and/or one or more transceivers (e.g., wireless transceiver(s)).

At block 1702, the process 1700 can include transmitting (e.g., by the base station 753 of FIG. 7 or gNB or base station 1016 of FIG. 10), to a user equipment (UE), a channel state information (CSI) reference signal on at least one of a first set of frequency units or a first set of antenna ports, wherein at least one of the first set of frequency units or the first set of antenna ports includes at least one of less than all available frequency units or less than all available antenna ports. At block 1704, the process 1700 can include receiving (e.g., by the base station 753 of FIG. 7 or gNB or base station 1016 of FIG. 10), from the UE, information associated with CSI on at least one of a second set of frequency units or a second set of antenna ports, wherein at least one of the second set of frequency units or the second set of antenna ports includes at least one of less than all available frequency units or less than all available antenna ports. At block 1706, the method can include generating (e.g., by the base station 753 of FIG. 7 or gNB or base station 1016 of FIG. 10), based on the information associated with the CSI, reconstructed CSI for at least one of a third set of frequency units or a third set of antenna ports.

An apparatus (e.g., the base station 753 of FIG. 7 or gNB or base station 1016 of FIG. 10) for wireless communication can include at least one memory and at least one processor coupled to the at least one memory and configured to: transmit, to a user equipment (UE), a channel state information (CSI) reference signal on at least one of a first set of frequency units or a first set of antenna ports, wherein at least one of the first set of frequency units or the first set of antenna ports includes at least one of less than all available frequency units or less than all available antenna ports; receive, from the UE, information associated with CSI on at least one of a second set of frequency units or a second set of antenna ports, wherein at least one of the second set of frequency units or the second set of antenna ports includes at least one of less than all available frequency units or less than all available antenna ports; and generate, based on the information associated with the CSI, reconstructed CSI for at least one of a third set of frequency units or a third set of antenna ports.

In some aspects, the techniques described herein relate to a non-transitory computer-readable storage medium (e.g., the memory 2415, 2420, 2425 of FIG. 24) including instructions stored thereon which, when executed by at least one processor, causes the at least one processor to: transmit, to a user equipment (UE), a channel state information (CSI) reference signal on at least one of a first set of frequency units or a first set of antenna ports, wherein at least one of the first set of frequency units or the first set of antenna ports includes at least one of less than all available frequency units or less than all available antenna ports; receive, from the UE, information associated with CSI on at least one of a second set of frequency units or a second set of antenna ports, wherein at least one of the second set of frequency units or the second set of antenna ports includes at least one of less than all available frequency units or less than all available antenna ports; and generate, based on the information associated with the CSI, reconstructed CSI for at least one of a third set of frequency units or a third set of antenna ports.

In some aspects, the techniques described herein relate to an apparatus for wireless communications (e.g., by the base station 753 of FIG. 7 or gNB or base station 1016 of FIG. 10) including one or more means for performing operations including: transmitting, to a user equipment (UE), a channel state information (CSI) reference signal on at least one of a first set of frequency units or a first set of antenna ports, wherein at least one of the first set of frequency units or the first set of antenna ports includes at least one of less than all available frequency units or less than all available antenna ports; receiving, from the UE, information associated with CSI on at least one of a second set of frequency units or a second set of antenna ports, wherein at least one of the second set of frequency units or the second set of antenna ports includes at least one of less than all available frequency units or less than all available antenna ports; and generating, based on the information associated with the CSI, reconstructed CSI for at least one of a third set of frequency units or a third set of antenna ports.

In some examples, the processes described herein (e.g., process 1600, 1700 and/or other process described herein) may be performed by a computing device or apparatus (e.g., a UE user equipment or a BS or base station). For example, the process 1700 may be performed by the system 2400 of FIG. 24 configured to implement the components of a UE 1002 or a gNB or base station 1016 of FIG. 10.

In some aspects, a deep learning-based join channel estimation and CSI feedback system is disclosed with low-density pilot signals for OFDM-MIMO systems. The downlink channel state information (CSI) plays an important role for improving throughput in massive MIMO systems. The downlink CSI is measured through channel state information reference signal (CSI-RS) by UEs and is reported back to BSs through feedback links. In current systems, the CSI is represented by standardized codebooks to reduce the feedback overhead. With the advances in machine learning (ML), the idea of using ML-based algorithms to improve CSI feedback (CSF) performance over the codebook-based CSF has been explored. However, most of the studies mainly consider the CSF with ideal or high-quality CSI which can be challenging to obtain in practical systems as the approach usually requires high-density CSI-RS or high CSI-RS transmission power. The following figures and examples introduce a framework for CSF with low-density pilot. The framework consists of two enhancements. First, separate channel estimation (CE) and CSF functions may suffer from error propagation with low-quality CE, so the concept includes jointly implementing CE and CSF. Second, the CE qualities are different for different portions of CSI. The disclosure introduces partial CSI reporting and leaves the interpolation task to the BS. The simulation results suggest that joint CE and CSF is better at certain cases and partial CSI reporting is beneficial for low-quality channel estimation cases.

In practical systems, the UE estimates the downlink CSI by measuring the channel state information reference signal (CSI-RS) transmitted by the BS. To obtain high accuracy CSI, denser CSI-RS can be used but at the cost of higher resource consumption, which may not be plausible in the systems where there are hundreds or thousands of antennas deployed at the BS, e.g., 6G systems. Therefore, obtaining high quality CSI feedback (CSF) performance with lower CSI-RS overhead can provide benefits. A joint design of the CSI estimation and CSI feedback under low-density CSI-RS is introduced.

A single user downlink MIMO system is considered with Nₜ transmit antennas at the BS and Nᵣ receive antennas at the UE. The system adopts an OFDM waveform and operates on N_{c} subcarriers. The received signal on the n^{th} subcarrier is represented by equation (1):

$${y}_{n} = {H}_{n}^{T} {w}_{n} x + {z}_{n} \qquad ( 1 )$$

where yₙ∈ [symbol] ^{N}^{ᵣ} is the signal received from Nᵣ antennas, Hₙ=[hₙ_{₁}, hₙ_{₂}, . . . , hₙ_{_{Nr}}]∈ [symbol] ^{N}^{ₜ}^{×N}^{ᵣ} is the channel on the n^{th} subcarrier of all Nᵣ receiving antennas, hₙ_{ᵢ}∈ [symbol] ^{N}^{ₜ} represents the channel on the n^{th} subcarrier of the i^{th} receiving antenna, wₙ∈ [symbol] ^{N}^{ₜ} is the multiplexing weight that multiplexes Nₜ antenna elements on the n^{th} subcarrier, x is the transmitted pilot, and zₙ∈ [symbol] ^{N}^{ᵣ} is the received additive noise.

Vectorizing equation (1) leads to:

$${y}_{n} = ( {I}_{{N}_{r}} ⊗ {w}_{n}^{T} ) {h}_{n} x + {z}_{n} , \qquad ( 2 )$$

where I_{N}_{ᵣ}∈ [symbol] ^{N}^{ᵣ}^{×N}^{ᵣ} is an identity matrix, and hₙ=vec(Hₙ∈ [symbol] ^{N}^{ₜ}^{,N}^{ᵣ}).

The approach includes splitting the Ne subcarriers into N/subcarrier blocks with each block containing P subcarriers and assume the channels within each block are frequency-flat. For example, for the i^{th} group, the result is:

$${h}_{i , 1} = {h}_{i , 2} = … = {h}_{i , P} ,$$

where h_{i,j}∈ [symbol] ^{N}^{ₜ}^{,N}^{ᵣ} is the channel on the j^{th} subcarrier in the i^{th} block. Therefore, there is only a need to consider the block-level channel. For notational simplicity, the approach uses hᵢ,∈ [symbol] ^{N}^{ₜ}^{,N}^{ᵣ} to represent the vectorized channel of the i^{th} block. Suppose the pilots occupy L≤P subcarriers in each block, the received signal for the i^{th} block is:

$${y}_{i} = {W}_{i} {h}_{i} + {z}_{i}$$

where yᵢ=vec(Yᵢ)∈ [symbol] ^{N}^{ᵣ}^{,L} with

$${Y}_{i} = ( \begin{matrix}{y}_{i , 1}^{T} \\ {y}_{i , 2}^{T} \\ ⋮ \\ {y}_{i , L}^{T}\end{matrix} )$$

and y_{i,j}∈ [symbol] ^{N}^{ᵣ} is the received signal on the j^{th} subcarrier in block i, Wᵢ=I_{N}_{ᵣ}⊗W_{i,L}^{T}∈ [symbol] ^{N}^{ᵣ}^{, L×N}^{ₜ}^{N}^{ᵣ} is the multiplying weight for the L subcarriers of block i and zᵢ∈ [symbol] ^{N}^{ᵣ}^{,L} is the additive noise. Let the channel on all N_{f} blocks be:

$$H = {[ {h}_{1} , {h}_{2} , … , {h}_{{N}_{f}} ]}^{T} ∈ {ℂ}^{{N}_{f} \times {N}_{t} {N}_{r}} \qquad ( 3 )$$

and assume the pilots are sent on N_{Y}≤N_{f} blocks, and then the channel on N_{Y} blocks is

$${H}_{y} = S H , \qquad ( 4 )$$

where S∈ [symbol] ^{N}^{_{Y}}^{×N}^{_{f}} is a selection matrix that consists only 1's and 0's. The selection matrix S has only one 1 in each row that selects N_{Y} rows of H, and hence H_{Y}∈ [symbol] ^{N}^{_{Y}}^{×N}^{ₜ}^{N}^{ᵣ}. Then the received signal on N_{Y} blocks is:

$$y = W {h}_{Y} x + z \qquad ( 5 )$$

where y=vec(Y)∈ [symbol] ^{N}^{_{Y}}^{N}^{ᵣ}^{L} with

$$Y = ( \begin{matrix}{y}_{1}^{T} \\ {y}_{2}^{T} \\ ⋮ \\ {y}_{{N}_{Y}}^{T}\end{matrix} ) .$$

In one aspect, W∈ [symbol] ^{N}^{_{Y}}^{N}^{ᵣ}^{L×N}^{_{Y}}^{N}^{ₜ}^{N}^{ᵣ} is the multiplexing weight for the N_{Y} blocks and is written as

$$W = ( \begin{matrix}{W}_{1} ⊗ {I}_{{N}_{f}} \\ {W}_{2} ⊗ {I}_{{N}_{f}} \\ ⋮ \\ {W}_{{N}_{Y}} ⊗ {I}_{{N}_{f}}\end{matrix} )$$

h_{Y}=vec(H_{Y})∈ [symbol] ^{N}^{_{Y}}^{N}^{ₜ}^{N}^{ᵣ}, and Z∈ [symbol] ^{N}^{_{Y}}^{N}^{ₜ}^{N}^{ᵣ}. The channel estimation task can be written as:

$$\hat{h} = min {‖ \hat{h} - h ‖}_{F}^{2} , \qquad ( 6 )$$

$$s . t . y = {Wh}_{Y} x + z$$

When one replaces h_{Y} with equation (4) and the result is:

$$\hat{h} = min {‖ \hat{h} - h ‖}_{F}^{2} \qquad ( 7 )$$

$$s . t . y = {WS}_{I} hx + z$$

$$where$$

$${S}_{I} = ( {I}_{{N}_{t} {N}_{r}} ⊗ S ) ∈ {ℂ}^{{N}_{Y} {N}_{t} {N}_{r} \times {N}_{f} {N}_{t} {N}_{r}} .$$

In one aspect, the approach can include defining the pilot overhead ratio as:

$$∝ = \frac{{N}_{Y} L}{{N}_{f} {N}_{t}} . \qquad ( 8 )$$

then the low-density pilot means ∝<<1, e.g., ∝=0.125. The case is considered where the pilot overhead reduction is achieved by using N_{Y}<<N_{f} subcarrier blocks and keep L=Nₜ, i.e., frequency reduction only. Without loss of generality, the approach can use W=I_{N}_{_{Y}}_{N}_{ₜ}_{N}_{ᵣ} and problem (7) can be written as:

$$\hat{h} = min {‖ \hat{h} - h ‖}_{F}^{2} \qquad ( 9 )$$

$$s . t . y = {S}_{I} h x + z$$

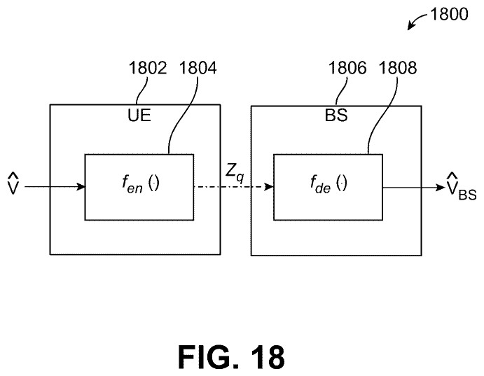

In some aspects, improvements are made with respect to how to accomplish CSI feedback. FIG. 18 illustrates a block diagram of a UE/BS system 1800 that includes a UE 1802 implementing a first operation fen(⋅) 1804 on received input V to generate z_{q} and a BS 1806 implementing a second operation fen(⋅) 1808 operating on z_{q} to generate V_{BS}. Implicit CSI feedback is considered where the precoders are fed back to the BS 1806. Before introducing the calculation of precoder, the approach is to first split the channel of (3) into N_{B} groups with each group containing S subcarrier blocks and rewrite the channel of (3) as

$$H = ( \begin{matrix}{\tilde{H}}_{1} \\ {\tilde{H}}_{2} \\ ⋮ \\ {\tilde{H}}_{{N}_{B}}\end{matrix} ) with {\tilde{H}}_{i} = ( \begin{matrix}{H}_{i , 1} \\ {H}_{i , 2} \\ ⋮ \\ {H}_{i , S}\end{matrix} ) \qquad ( 10 )$$

where \tilde{H}ᵢ, is the channel on the ith subcarrier block and H_{i,j}∈ [symbol] ^{N}^{ₜ}^{×N}^{ᵣ} is the channel on the j^{th} subcarrier block of the i^{th} group. The precoder is calculated per group through the following process:
(1) average the spatial correlation among the transmitting antennas over S subcarrier blocks for each group. For the i^{th} group, the averaged Tx spatial correlation is calculated as

$${R}_{i} = \frac{1}{S} {\sum }_{s = 1}^{S} {H}_{i , s} {H}_{i , s}^{H}$$

(2) Secondly, calculated the left of Rᵢ denoted as

$${V}_{i}^{R} ∈ {ℂ}^{{N}_{t} \times {N}_{r}} .$$

There can be at most Nᵣ layers where

$${V}_{i}^{R} ( : , r )$$

in the precoder of the r^{th} layer.
(3) Finally, aggregate the precoders of different layers for all N_{B} groups.

In some aspects, the approach only considers the first layer. For notational simplicity, one can use vᵢ∈ [symbol] ^{N}^{ₜ} to represent the layer-1 precoder for the i^{th} group, and the resulted precoder for all N_{B} groups is:

$$V = [ {v}_{1}^{T} , {v}_{2}^{T} , … , {v}_{{N}_{B}}^{T} ] ∈ {ℂ}^{{N}_{B} \times {N}_{t}} \qquad ( 12 )$$

Denote by p(⋅) the operation of precoder calculation, the above process can be summarized as:

$$V = p ( H ) .$$

In practice, the UE can only obtain the precoder as:

$$\hat{V} = p ( \hat{H} )$$

where Ĥ is the estimated channel obtained by solving (7).

For CSF, the UE encodes \hat{V} by using the operation fen(⋅):

$${z}_{q} = {f}_{e n} ( \hat{V} )$$

where z_{q} is the bit stream that being fed back to the BS. The BS decodes z_{q} through f_{de}(⋅) and gets

$${\hat{V}}_{BS} = {f}_{de} ( {z}_{q} ) ,$$

where \hat{V}_{BS}∈ [symbol] ^{N}^{_{B}}^{×N}^{ₜ} is the precoder recovered by the BS 1806.

If the BS 1806 uses low-density, the channel estimation can be inaccurate and hence cause error propagation when feeding back the inaccurate \hat{V}. In some aspects, one can first show the problem of CSF with low-density pilot and then present the disclosed solutions.

The CSF under low density pilot is discussed next. First, the properties of the estimated precoder V under low-density CSI-RS are discussed along with the issues of the CSF with V and the disclosed solutions.

Properties of the estimated precoder can be shown for the V under low-density pilot by first solving problem (9) by using the linear minimum mean square error (LMMSE) channel estimator. Using the notation in (9), the LMMSE weight is derived as:

$${W}_{LMMSE} = {R}_{hh} {{S}_{l}^{H} ( {S}_{l} {R}_{hh} {S}_{l}^{H} + {σ}^{2} I )}^{- 1} , \qquad ( 13 )$$

where Rₕₕ∈ [symbol] ^{N}^{_{f}}^{N}^{ₜ}^{N}^{ᵣ}^{×N}^{_{f}}^{N}^{ₜ}^{N}^{ᵣ} is the channel covariance matrix across all transmit antennas, receive antennas, and subcarrier blocks, and cr² is the variance of the additive Gaussian noise. Then the channel is estimated as:

$${\hat{h}}_{LMMSE} = {W}_{LMMSE} y ,$$

and further the approach obtains:

$$\begin{matrix}{\hat{H}}_{LMMSE} = v e {c}^{- 1} ( {\hat{h}}_{LMMSE} ) = and \\ \hat{V} = p ( {\hat{H}}_{LMMSE} )\end{matrix}$$

To show how well \hat{V} is estimated, the approach uses the squared generalized cosine similarity (SGCS) as the metric, which is calculated as:

$$SGCS ( {\hat{v}}_{i} , {v}_{i} ) = \frac{{‖ {\hat{v}}_{i}^{H} {v}_{i} ‖}^{2}}{{‖ {v}_{t}^{H} {v}_{i} ‖}^{2}} \qquad ( 14 )$$

Since ∥\hat{v}ᵢ∥=∥vᵢ∥=1 so that SGCS(\hat{v}ᵢ, vᵢ)≤1, and SGCS(\hat{v}ᵢ, vᵢ)=1 if (vᵢ, vᵢ).

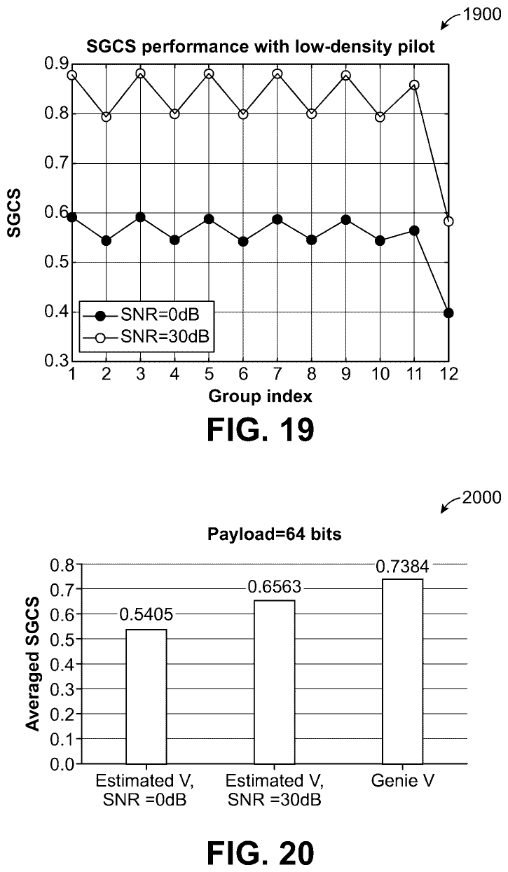

FIG. 19 shows a graph 1900 of the SGCS performance of the estimated precoder with (∝, N_{f}, N_{B}=(0.125, 48, 12). The pilot is transmitted on every 1/∝=8 subcarrier block and since there are S=4 subcarrier blocks in each group, in one aspect, the approach only has observations on 6 out of 12 groups. Let G be the set of groups that the pilots are transmitted on and G′ be the set of groups that no pilots are transmitted on, and then for the evaluation setting of FIG. 19, one can have G={1, 3, 5, 7, 9, 11} and G′={2, 4, 6, 8, 10, 12}. Denote by \hat{V}_{G} the estimated precoders for the groups in G and \hat{V}_{G′}, the estimated precoders for the groups in G′. One can observe from FIG. 19 that the SGCS performance for \hat{V}_{G} is better than \hat{V}_{G}, in general. The performance gap between \hat{V}_{G} and \hat{V}_{G′}, is very large for some groups, e.g., the SGCS loss of the 12^{th} group relative to the 1^{st} group is 32.7% at SNR=0 dB and 33.6% at SNR=30 dB. The approach suggests that interpolating/extrapolating the precoders for the groups in G′ is more challenging.

There can be further issues and a solution as well. To show how an inaccurate estimation of precoders affect the CSF performance, one approach is to evaluate the CSF performance by using the autoencoder structure in FIG. 18 where one can choose the transformer (TF) structure as fₑₙ(⋅) 1804 and f_{de}(⋅) 1808. The performance metric used for CSF is the averaged SGCS calculated as:

$$S G C {S}_{a v g} ( \hat{V} , V ) = \frac{1}{s} {\sum }_{i = 1}^{S} \frac{{‖ {\hat{v}}_{i}^{H} {v}_{i} ‖}^{2}}{{‖ {v}_{t}^{H} {v}_{i} ‖}^{2}} \qquad ( 15 )$$

An example result is shown in FIG. 20 which shows a graph 2000 of the averaged SGCS performance for CSF. From FIG. 20, one can see that the performance drop of \hat{V} compared to V is clear with 26.8% at SNR=0 dB and 11.1% at SNR=30 dB. Based on the observations discussed above, the approach can improve the CSF performance in two aspects.

A first example improvement can relate to the channel estimation performance. The channel estimation results shown in FIG. 19 is obtained by the LMMSE estimator which can be improved by deep learning-based techniques. Different from the works that target on improving the CE performance only, the approach disclosed herein optimizes the CE and CSF performance together by training one joint CE and CSF neural network.

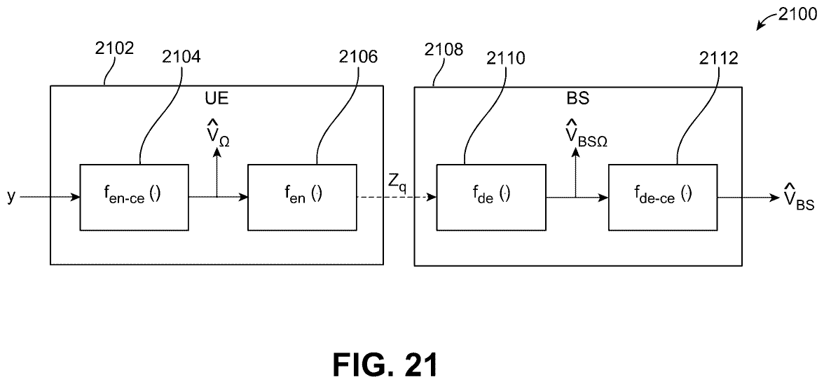

FIG. 21 illustrates an improved UE/BS system 2100. Another example improvement is that the UE 2102 only feeds back partial precoders. Specifically, let Ω be the set that contains N_{P}≤N_{B} groups of precoders that the UE 2102 chose to feedback at \hat{V}_{Ω}∈ [symbol] ^{N}^{_{P}}^{×N}^{ₜ} be the estimated precoders for the groups in Ω, and then the result can be:

$${\hat{V}}_{Ω} = {f}_{e n - c e} ( y ) , and {z}_{q} = {f}_{e n} ( {\hat{V}}_{Ω} )$$

where \hat{V}_{Ω}(′) represents the operations to estimate \hat{V}_{Ω} from y. Upon receiving z_{q}, the BS 2108 performs two operations:

$${\hat{V}}_{B {S}_{Ω}} = {f}_{de} ( {z}_{q} ) and {\hat{V}}_{B S} = {f}_{a e - c e} ( {\hat{V}}_{B {S}_{Ω}} )$$

where \hat{V}_{BS}_{_{Ω}} is the decoded \hat{V}_{Ω} at the BS side, and f_{de-ce}(⋅) 2112 represents the operation at the BS side to estimate all the N_{B} precoders. Based on the observations in FIG. 18, the CE performance for the groups in G′ is worse than that in G, and in one aspect, the UE 2102 can choose Ω=G and feedback only \hat{V}_{G} and leave the interpolation/extrapolation of the precoders in G′ to the BS 2108. In one way, the error propagation caused by inaccurate \hat{V}_{G′}, can be alleviated.

Therefore, a joint CE and CSF framework or UE/BS system 2100 is proposed for joint CE and CSF with low-density pilot shown in FIG. 21. As explained above, the UE 2102 receives input y and a first UE operation f_{en-ce} (y) 2104 on y to generate \hat{V}_{Ω}. A second UE operation fₑₙ(\hat{V}_{Ω}) 2106 processes \hat{V}_{Ω} to generate z_{q}, which is transmitted to the BS 2108. The BS 2108 includes a first BS operation f_{de}(z_{q}) 2110 to generate \hat{V}_{BS}_{_{Ω}} from z_{q} which is then processed by a second BS operation f_{de-ce} (\hat{V}_{BS}_{_{Ω}}) 2112 to generate \hat{V}_{BS}_{_{Ω}}.

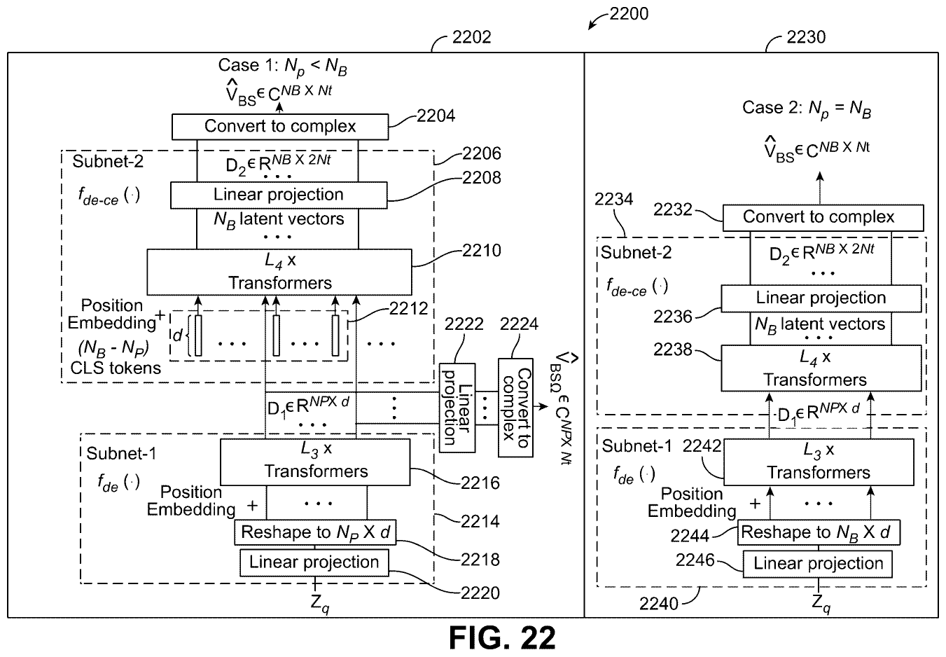

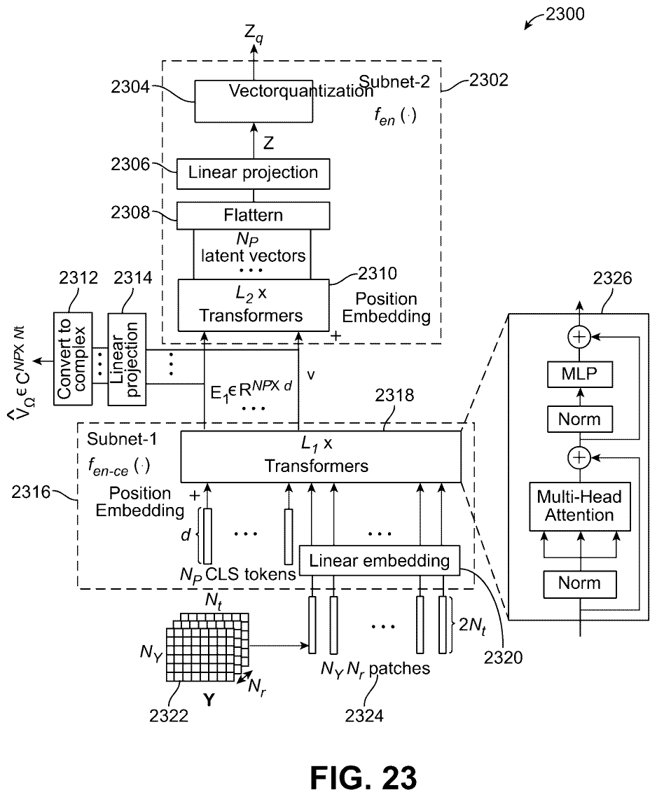

FIG. 22 illustrates an example neural network (NN) structure with two cases 2200 for different decoders. A first BS side decoder 2202 and a second BS side decoder 2230 are illustrated for implementing the proposed framework. FIG. 23 illustrates a NN structure for a UE side encoder 2300. The UE side encoder 2300 obtains the received signal y as input and then compresses the signal y to z_{q}. There are two subnets at the UE side, i.e., fₑₙ(⋅) and f_{en-ce} as shown in FIG. 23. The NN structures for these two subnets is described. The structures for the two subnets are adapted from a vision transformer (VIT).

The UE side encoder 2300 includes a subnet-1 2316: The function of the subnet-1 2316 is to map Y∈ [symbol] ^{N}^{_{Y}}^{×N}^{ₜ}^{×N}^{_{y}} into E₁ that has size Np×d. The concept of a CLS token is used as E₁. A CLS token is concatenated to the input image tokens and are sent to the transformer for an attention calculation. The CLS token is considered as a learned representation of the image and is used for calculating the classification score. In the design, CLS tokens are used to be learned to represent Y 2322. In particular, that approach firstly reshape y into Y∈ [symbol] ^{N}^{_{Y}}^{N}^{ᵣ}^{×N}^{ₜ} and split the Y̅ into NyNᵣ patches 2324 with each patch has size 1×2Nₜ. The approach then obtains NyNᵣ tokens by projecting each of the patches into a d-dimensional latent vector through a linear layer 2320. Finally, N_{P} d-dimensional CLS tokens are concatenated to the NyNᵣ tokens and sent into L₁ transformers 2318. The L₁ transformers 2318 can be represented by transformer module 2326 that includes one or more a first normalization component, a multi-head attention module an addition component, a second normalization component and a multilayer perceptron with a further addition component. The attention of the multi-head attention component in the transformer module 2326 can be calculated across all the (N_{P})+N_{Y}Nᵣ tokens but only the N_{P} latent vectors that correspond to the N_{P} CLS tokens are kept at the output of subnet-1 2316. The output can also be provided to a linear projection 2314 which output is converted to complex numbers via a component that convert data to complex values 2312.

The UE side encoder 2300 includes subnet-2 2302. The function of subnet-2 2302 is to compress E₁ to a M-dimensional 1D vector z and then quantize it to z_{q}. The data from the subnet-1 2316 can be provided to transformers 2310 which output data is further processed by a flatten component 2308 with its output processed by a linear projection component 2306 which produces z. In some aspects, vector quantization (VQ) 2304 can be used. The VQ 2304 maps z into a codebook C∈ [symbol] ^{M×K} that consists of K vectors; cᵢ∈ [symbol] ^{M} and can obtain:

$${z}_{q} = {c}_{k} where k = \frac{argmin {‖ z - {c}_{i} ‖}_{F}^{2}}{i}$$

The codebook C is learned together with the encoder and decoder.

FIG. 22 illustrates two example BS side NN structures for the two cases 2200. In a first case, the first BS side decoder 2202 applies when Np<nB. The first BS side decoder 2202 takes z_{q} as input and recovers NB precoders \hat{V}_{BS}∈ [symbol] ^{N}^{_{B}}^{×N}^{ₜ}. The first BS side decoder 2202 consists of two subnets, i.e., a first subnet as subnet-1 2214 f_{de}(⋅) and a second subnet known as subnet-2 2206 f_{de-ce} as shown in FIG. 22. The subnet-1 2214 maps the 1D vector z into D₁∈ [symbol] ^{N}^{_{P}}^{×N}^{ₜ} and subnet-2 takes D1 and recovers the NB precoders \hat{V}_{BS}. These two subnets also use the transformer structure such as a first transformer 2216 in the subnet-1 2214 and a second transformer 2210 in subnet-2 2206.

The subnet-1 2214 includes a flatten layer 2218, a linear layer 1820, and L3 transformers as the first transformer 2216, and it has a similar structure as the subnet-2 2302 of the encoder in FIG. 23.

The subnet-2 2206 can include L4 transformers as the second transformer 2210 and a linear layer 2208.

As noted above, for case 1 where N_{P}<N_{B}, which means the column dimension of D1 is smaller than the column dimension of \hat{V}_{BS}. In one aspect, the approach is to concatenate (N_{P}−N_{B}) d-dimensional CLS tokens to D1 and send them to the L4 transformers as the second transformer 2210. The output of the transformers is then projected to D₂∈ [symbol] ^{N}^{_{B}}^{×2N}^{ₜ} through a linear layer 2208 and the recovered precoder V∈ [symbol] ^{N}^{_{B}}^{×N}^{ₜ} is obtained by organizing the values in D2 into complex values using the linear projector 2222 and a component to convert to complex numbers 2224.

The second BS side decoder 2230 applies to case 2 where N_{P}=N_{B}, which means the column dimension of D1 is the same as the column dimension of \hat{V}_{BS}. In one aspect, the approach is to not use any CLS tokens and send D1 directly into the subnet-2 2234. The second BS side decoder 2230 includes subnet 1 2340, a linear projection 2346, a reshaping flatten component 2344, and transformers 2342. The second BS side decoder 2230 also includes a subnet-2 2334 which has transformers 2338 and a linear layer 2336 as well as a component to convert values to complex numbers 2332.

For case 1 in FIG. 23, an approach can be applied to train the encoder and decoder jointly by using the following loss function

$$L ( Θ ) = \frac{1}{N} {\sum }_{i = 1}^{N} g ( \hat{V} , V ) + α \frac{1}{N} {\sum }_{i = 1}^{N} g ( {\hat{V}}_{Ω} , {V}_{Ω} ) \qquad ( 16 )$$

$$+ β \frac{1}{N} {\sum }_{i = 1}^{N} g ( {\hat{V}}_{{BS}_{Ω}} , {V}_{Ω} ) \qquad ( 17 )$$

$$+ V {Q}_{l o s s} , \qquad ( 18 )$$

where Θ represents all the parameters to be learned in the encoder and decoder, ∝≥0 and β≥0 are hyperparameters, g(\hat{V}, V) is the MSE loss between V\hat{ } and V calculated as:

$$g ( \hat{V} , V ) = {‖ \hat{v} ‖}_{F}^{2} + {v}_{F}^{2} - 2 {‖ {\hat{V}}^{H} \hat{V} ‖}_{F} .$$

Here, V_{P}∈ [symbol] ^{N}^{_{P}}^{×N}^{ₜ} represents the precoders on N_{P} groups, \hat{V}_{Ω}∈ [symbol] ^{N}^{_{P}}^{×N}^{ₜ} is obtained by firstly projecting E₁∈ [symbol] ^{N}^{ₚ}^{×d} into E₁∈ [symbol] ^{N}^{ₚ}^{×2N}^{ₜ} and then organizing the values in it into complex values, and \hat{V}_{BS}_{_{Ω}}∈ [symbol] ^{N}^{ₚ}^{×N}^{ₜ} is obtained in the same manner as \tilde{E}₁. The VQₗₒₛₛ is calculated as:

$$V {Q}_{loss} = {‖ sg [ z ] - c ‖}_{F}^{2} + ϒ {‖ z - s g [ c ] ‖}_{F}^{2} ,$$

where sg[⋅] stands for stopgradient operator that only applies forward computation for its input but applies zero partial derivatives in the backpropagation, c∈ [symbol] ^{M} stands for the codebook vector to be learned, and Y is a hyperparameter.

For case 2, the approach is to train the encoder and decoder jointly by using the following loss function

$$L ( θ ) = \frac{1}{N} {\sum }_{i = 1}^{N} g ( \hat{V} , V ) + α \frac{1}{N} {\sum }_{i = 1}^{N} g ( {\hat{v}}_{Ω} ) , {v}_{Ω} \qquad ( 19 )$$

$$+ V {Q}_{l o s s} , \qquad ( 20 )$$

FIG. 24 is a diagram illustrating an example of a system for implementing certain aspects of the present technology. In particular, FIG. 24 illustrates an example of computing system 2400, which may be for example any computing device making up internal computing system, a remote computing system, a camera, or any layer thereof in which the components of the system are in communication with each other using connection 2405. Connection 2405 may be a physical connection using a bus, or a direct connection into processor 2410, such as in a chipset architecture. Connection 2405 may also be a virtual connection, networked connection, or logical connection.

In some aspects, computing system 2400 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 2400 includes at least one processing unit (CPU or processor) 2410 and connection 2405 that communicatively couples various system components including system memory 2415, such as read-only memory (ROM) 2420 and random access memory (RAM) 2425 to processor 2410. Computing system 2400 may include a cache 2412 of high-speed memory connected directly with, in close proximity to, or integrated as part of processor 2410.

Processor 2410 may include any general purpose processor and a hardware service or software service, such as services 2432, 2434, and 2436 stored in storage device 2430, configured to control processor 2410 as well as a special-purpose processor where software instructions are incorporated into the actual processor design. Processor 2410 may essentially be a completely self-contained computing system, containing multiple cores or processors, a bus, memory controller, cache, etc. A multi-core processor may be symmetric or asymmetric.

To enable user interaction, computing system 2400 includes an input device 2445, which may represent any number of input mechanisms, such as a microphone for speech, a touch-sensitive screen for gesture or graphical input, keyboard, mouse, motion input, speech, etc. Computing system 2400 may also include output device 2435, which may be one or more of a number of output mechanisms. In some instances, multimodal systems may enable a user to provide multiple types of input/output to communicate with computing system 2400.

Computing system 2400 may include communications interface 2440, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 2440 may also include one or more Global Navigation Satellite System (GNSS) receivers or transceivers that are used to determine a location of the computing system 2400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2430 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 2430 may include software services, servers, services, etc., that when the code that defines such software is executed by the processor 2410, it causes the system to perform a function. In some aspects, a hardware service that performs a particular function may include the software component stored in a computer-readable medium in connection with the necessary hardware components, such as processor 2410, connection 2405, output device 2435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

FIG. 19 is a diagram illustrating examples of neural network architectures for a base station for implementing certain aspects of the present technology; and

FIG. 20 is a diagram illustrating an example of a neural network architecture for a UE for implementing certain aspects of the present technology.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function). A

The various illustrative logical blocks, modules, circuits, and algorithm steps described in connection with the examples disclosed herein may be implemented as electronic hardware, computer software, firmware, or combinations thereof. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method of wireless communications at a user equipment (UE), the method comprising: receiving, from a base station, a channel state information (CSI) reference signal on at least one of a first set of frequency units or a first set of antenna ports, wherein at least one of the first set of frequency units or the first set of antenna ports includes at least one of less than all available frequency units or less than all available antenna ports; generating CSI based on the CSI reference signal; and transmitting, from the UE to the base station, information associated with the CSI on at least one of a second set of frequency units or a second set of antenna ports for use in reconstructing the CSI on at least one of a third set of frequency units or a third set of antenna ports, wherein at least one of the second set of frequency units or the second set of antenna ports includes at least one of less than all available frequency units or less than all available antenna ports.

Aspect 2. The method of Aspect 1, wherein at least one of the second set of frequency units or the second set of antenna ports is determined based at least in part on at least one of the first set of frequency units or the first set of antenna ports, at least one of the third set of frequency units or the third set of antenna ports, a received signal power, an interference level, a channel estimation accuracy of the CSI reference signal, or based on configuration information received from the base station.

Aspect 3. The method of any one of Aspects 1 or 2, wherein the third set of frequency units comprises all available frequency units and the third set of antenna ports comprises all available antenna ports.

Aspect 4. The method of any one of Aspects 1 to 3, wherein receiving the CSI reference signal further comprises receiving the CSI reference signal on the first set of frequency units and via the first set of antenna ports.

Aspect 5. The method of Aspect 4, wherein transmitting the information associated with the CSI comprises transmitting the information associated with the CSI on the second set of frequency units and using the second set of antenna ports.

Aspect 6. The method of any one of Aspects 1 to 5, wherein the first set of frequency units and the second set of frequency units are a same set of frequency units.

Aspect 7. The method of any one of Aspects 1 to 6, wherein the second set of frequency units include a subband with at least one resource block containing the CSI reference signal.

Aspect 8. The method of any one of Aspects 1 to 7, wherein the second set of frequency units includes the first set of frequency units and at least one additional frequency unit.

Aspect 9. The method of Aspect 8, wherein the at least one additional frequency unit is configured by a network or determined based on pre-defined rules.

Aspect 10. The method of any one of Aspects 1 to 9, wherein the second set of frequency units are in a subband associated with a high channel estimation quality across at least one of a set of resource blocks or a set of subbands.

Aspect 11. The method of Aspect 10, wherein the high channel estimation quality is determined based on at least one of a high reference signal received power, a high interference, a high noise measurement, or a resource close to the CSI reference signal.

Aspect 12. The method of any one of Aspects 1 to 11, wherein the first set of frequency units and the first set of antenna ports are the same as the second set of frequency units and the second set of antenna ports.

Aspect 13. The method of any one of Aspects 1 to 12, wherein the second set of frequency units and the second set of antenna ports includes the first set of frequency units and the first set of antenna ports and at least one additional antenna port.

Aspect 14. The method of Aspect 13, wherein the at least one additional antenna port is one of pre-defined, based on configuration information received from the base station, or reported by the user equipment.

Aspect 15. The method of any one of Aspects 1 to 14, wherein the second set of antenna ports comprises all available antenna ports or a selected set of antenna ports.

Aspect 16. The method of Aspect 15, wherein the second set of antenna ports comprises the selected set of antenna ports, and wherein the selected set of antenna ports are pre-defined or are based on configuration information received from the base station.

Aspect 17. The method of any one of Aspects 1 to 16, wherein the first set of frequency units, the second set of frequency units, and the third set of frequency units are different sets of frequency units.

Aspect 18. The method of Aspect 17, wherein the first set of antenna ports, the second set of antenna ports, and the third set of frequency units are different sets of antenna ports.

Aspect 19. The method of any one of Aspects 17 or 18, wherein the third set of frequency units comprise all available frequency units.

Aspect 20. The method of any one of Aspects 1 to 19, wherein at least the first set of frequency units or the first set of antenna ports is configured based on a resource pattern of the CSI reference signal.

Aspect 21. The method of any one of Aspects 1 to 20, wherein at least the third set of frequency units or the third set of antenna ports is at least one of configured based on a CSI reporting subband configuration or is dependent on at least one of the second set of frequency units or the second set of antenna ports.

Aspect 22. The method of any one of Aspects 1 to 21, wherein at least the second set of frequency units or the second set of antenna ports is at least one of pre-defined, based on configuration information received from the base station, or transmitted in a CSI report including the information associated with the CSI.

Aspect 23. The method of any one of Aspects 1 to 22, wherein the information associated with CSI includes a latent representation of the CSI generated using a machine learning encoder.

Aspect 24. An apparatus for wireless communication, the apparatus comprising: at least one memory; and at least one processor coupled to the at least one memory and configured to: receive, from a base station, a channel state information (CSI) reference signal on at least one of a first set of frequency units or a first set of antenna ports, wherein at least one of the first set of frequency units or the first set of antenna ports includes at least one of less than all available frequency units or less than all available antenna ports; generate CSI based on the CSI reference signal; and transmit, to the base station, information associated with the CSI on at least one of a second set of frequency units or a second set of antenna ports for use in reconstructing the CSI on at least one of a third set of frequency units or a third set of antenna ports, wherein at least one of the second set of frequency units or the second set of antenna ports includes at least one of less than all available frequency units or less than all available antenna ports.

Aspect 25. The apparatus of Aspect 24, wherein at least one of the second set of frequency units or the second set of antenna ports is determined based at least in part on at least one of the first set of frequency units or the first set of antenna ports, at least one of the third set of frequency units or the third set of antenna ports, a received signal power, an interference level, a channel estimation accuracy of the CSI reference signal, or based on configuration information received from the base station.

Aspect 26. The apparatus of any one of Aspects 24 or 25, wherein the third set of frequency units comprises all available frequency units and the third set of antenna ports comprises all available antenna ports.

Aspect 27. The apparatus of any one of Aspects 24 to 26, wherein receiving the CSI reference signal further comprises receiving the CSI reference signal on the first set of frequency units and via the first set of antenna ports.

Aspect 28. The apparatus of any one of Aspects 24 to 27, wherein transmitting the information associated with the CSI comprises transmitting the information associated with the CSI on the second set of frequency units and using the second set of antenna ports.

Aspect 29. The apparatus of any one of Aspects 24 to 28, wherein the first set of frequency units and the second set of frequency units are a same set of frequency units.

Aspect 30. The apparatus of any one of Aspects 24 to 29, wherein the second set of frequency units include a subband with at least one resource block containing the CSI reference signal.

Aspect 31. The apparatus of any one of Aspects 24 to 30, wherein the second set of frequency units includes the first set of frequency units and at least one additional frequency unit.

Aspect 32. The apparatus of Aspect 31, wherein the at least one additional frequency unit is configured by a network or determined based on pre-defined rules.

Aspect 33. The apparatus of any one of Aspects 24 to 32, wherein the second set of frequency units are in a subband associated with a high channel estimation quality across at least one of a set of resource blocks or a set of subbands.

Aspect 34. The apparatus of Aspect 33, wherein the high channel estimation quality is determined based on at least one of a high reference signal received power, a high interference, a high noise measurement, or a resource close to the CSI reference signal.

Aspect 35. The apparatus of any one of Aspects 24 to 34, wherein the first set of frequency units and the first set of antenna ports are the same as the second set of frequency units and the second set of antenna ports.

Aspect 36. The apparatus of any one of Aspects 24 to 35, wherein the second set of frequency units and the second set of antenna ports includes the first set of frequency units and the first set of antenna ports and at least one additional antenna port.

Aspect 37. The apparatus of Aspect 36, wherein the at least one additional antenna port is one of pre-defined, based on configuration information received from the base station, or reported by the user equipment.

Aspect 38. The apparatus of any one of Aspects 24 to 37, wherein the second set of antenna ports comprises all available antenna ports or a selected set of antenna ports.

Aspect 39. The apparatus of Aspect 38, wherein the second set of antenna ports comprises the selected set of antenna ports, and wherein the selected set of antenna ports are pre-defined or are based on configuration information received from the base station.

Aspect 40. The apparatus of any one of Aspects 24 to 39, wherein the first set of frequency units, the second set of frequency units, and the third set of frequency units are different sets of frequency units.

Aspect 41. The apparatus of any one of Aspects 24 to 40, wherein the first set of antenna ports, the second set of antenna ports, and the third set of frequency units are different sets of antenna ports.

Aspect 42. The apparatus of any one of Aspects 24 to 41, wherein the third set of frequency units comprise all available frequency units.

Aspect 43. The apparatus of any one of Aspects 24 to 42, wherein at least the first set of frequency units or the first set of antenna ports is configured based on a resource pattern of the CSI reference signal.

Aspect 44. The apparatus of any one of Aspects 24 to 43, wherein at least the third set of frequency units or the third set of antenna ports is at least one of configured based on a CSI reporting subband configuration or is dependent on at least one of the second set of frequency units or the second set of antenna ports.

Aspect 45. The apparatus of any one of Aspects 24 to 44, wherein at least the second set of frequency units or the second set of antenna ports is at least one of pre-defined, based on configuration information received from the base station, or transmitted in a CSI report including the information associated with the CSI.

Aspect 46. The apparatus of any one of Aspects 24 to 45, wherein the information associated with CSI includes a latent representation of the CSI generated using a machine learning encoder.

Aspect 47. A method of wireless communication at a base station, the method comprising: transmitting, to a user equipment (UE), a channel state information (CSI) reference signal on at least one of a first set of frequency units or a first set of antenna ports, wherein at least one of the first set of frequency units or the first set of antenna ports includes at least one of less than all available frequency units or less than all available antenna ports; receiving, from the UE, information associated with CSI on at least one of a second set of frequency units or a second set of antenna ports, wherein at least one of the second set of frequency units or the second set of antenna ports includes at least one of less than all available frequency units or less than all available antenna ports; and generating, based on the information associated with the CSI, reconstructed CSI for at least one of a third set of frequency units or a third set of antenna ports.

Aspect 48. An apparatus for wireless communication, the apparatus comprising: at least one memory; and at least one processor coupled to the at least one memory and configured to: transmit, to a user equipment (UE), a channel state information (CSI) reference signal on at least one of a first set of frequency units or a first set of antenna ports, wherein at least one of the first set of frequency units or the first set of antenna ports includes at least one of less than all available frequency units or less than all available antenna ports; receive, from the UE, information associated with CSI on at least one of a second set of frequency units or a second set of antenna ports, wherein at least one of the second set of frequency units or the second set of antenna ports includes at least one of less than all available frequency units or less than all available antenna ports; and generate, based on the information associated with the CSI, reconstructed CSI for at least one of a third set of frequency units or a third set of antenna ports.

Aspect 49. A non-transitory computer-readable storage medium comprising instructions stored thereon which, when executed by at least one processor, causes the at least one processor to perform operations according to any of Aspects 1-23 and 47.

Aspect 50. An apparatus for wireless communications comprising one or more means for performing operations according to any of Aspects 1-23 and 47.

Aspect 49. A non-transitory computer-readable storage medium including instructions stored thereon which, when executed by at least one processor, causes the at least one processor to perform operations according to any of Aspects 1-23 and 47.

Aspect 50. An apparatus for wireless communications including one or more means for performing operations according to any of Aspects 1-23 and 47.

1. An apparatus for wireless communication, the apparatus comprising:
at least one memory; and
at least one processor coupled to the at least one memory and configured to:
receive, from a base station, a channel state information (CSI) reference signal on at least one of a first set of frequency units or a first set of antenna ports, wherein at least one of the first set of frequency units or the first set of antenna ports includes at least one of less than all available frequency units or less than all available antenna ports;
generate CSI based on the CSI reference signal; and
transmit, to the base station, information associated with the CSI on at least one of a second set of frequency units or a second set of antenna ports for use in reconstructing the CSI on at least one of a third set of frequency units or a third set of antenna ports, wherein at least one of the second set of frequency units or the second set of antenna ports includes at least one of less than all available frequency units or less than all available antenna ports.

2. The apparatus of claim 1, wherein the at least one processor is configured to determine at least one of the second set of frequency units or the second set of antenna ports based at least in part on at least one of the first set of frequency units or the first set of antenna ports, at least one of the third set of frequency units or the third set of antenna ports, a received signal power, an interference level, a channel estimation accuracy of the CSI reference signal, or configuration information received from the base station.

3. The apparatus of claim 1, wherein the third set of frequency units comprises all available frequency units and the third set of antenna ports comprises all available antenna ports.

4. The apparatus of claim 1, wherein the at least one processor is configured to receive the CSI reference signal on the first set of frequency units and via the first set of antenna ports.

5. The apparatus of claim 1, wherein the at least one processor is configured to transmit the information associated with the CSI on the second set of frequency units and using the second set of antenna ports.

6. The apparatus of claim 1, wherein the first set of frequency units and the second set of frequency units are a same set of frequency units, wherein the second set of frequency units include a subband with at least one resource block containing the CSI reference signal, and wherein the second set of frequency units includes the first set of frequency units and at least one additional frequency unit.

7. The apparatus of claim 6, wherein the at least one additional frequency unit is configured by a network or determined based on pre-defined rules and wherein the second set of frequency units are in a subband associated with a high channel estimation quality across at least one of a set of resource blocks or a set of subbands.

8. The apparatus of claim 7, wherein the at least one processor is configured to determine the high channel estimation quality based on at least one of a high reference signal received power, a high interference, a high noise measurement, or a resource close to the CSI reference signal.

9. The apparatus of claim 1, wherein the first set of frequency units and the first set of antenna ports are the same as the second set of frequency units and the second set of antenna ports.

10. The apparatus of claim 1, wherein the second set of frequency units and the second set of antenna ports includes the first set of frequency units and the first set of antenna ports and at least one additional antenna port.

11. The apparatus of claim 10, wherein the at least one additional antenna port is one of pre-defined, based on configuration information received from the base station, or reported by a user equipment.

12. The apparatus of claim 1, wherein the second set of antenna ports comprises all available antenna ports or a selected set of antenna ports.

13. The apparatus of claim 12, wherein the second set of antenna ports comprises the selected set of antenna ports, and wherein the selected set of antenna ports are pre-defined or are based on configuration information received from the base station.

14. The apparatus of claim 1, wherein the first set of frequency units, the second set of frequency units, and the third set of frequency units are different sets of frequency units.

15. The apparatus of claim 1, wherein the first set of antenna ports, the second set of antenna ports, and the third set of frequency units are different sets of antenna ports.

16. (canceled)

17. The apparatus of claim 1, wherein at least the first set of frequency units or the first set of antenna ports is configured based on a resource pattern of the CSI reference signal, and wherein at least the third set of frequency units or the third set of antenna ports is at least one of configured based on a CSI reporting subband configuration or is dependent on at least one of the second set of frequency units or the second set of antenna ports.

18. The apparatus of claim 1, wherein at least the second set of frequency units or the second set of antenna ports is at least one of pre-defined based on configuration information received from the base station or transmitted in a CSI report including the information associated with the CSI.

19. The apparatus of claim 1, wherein the information associated with CSI includes a compressed representation of the CSI generated using a machine learning model.

20. (canceled)

21. A method of wireless communications at a user equipment (UE), the method comprising:
receiving a channel state information (CSI) reference signal on at least one of a first set of frequency units or a first set of antenna ports, wherein at least one of the first set of frequency units or the first set of antenna ports includes at least one of less than all available frequency units or less than all available antenna ports;
generating CSI based on the CSI reference signal; and
transmitting information associated with the CSI on at least one of a second set of frequency units or a second set of antenna ports for use in reconstructing the CSI on at least one of a third set of frequency units or a third set of antenna ports, wherein at least one of the second set of frequency units or the second set of antenna ports includes at least one of less than all available frequency units or less than all available antenna ports.

22-28. (canceled)

29. An apparatus for wireless communication, the apparatus comprising:
at least one memory; and
at least one processor coupled to the at least one memory and configured to:
transmit, to a user equipment (UE), a channel state information (CSI) reference signal on at least one of a first set of frequency units or a first set of antenna ports, wherein at least one of the first set of frequency units or the first set of antenna ports includes at least one of less than all available frequency units or less than all available antenna ports;
receive, from the UE, information associated with CSI on at least one of a second set of frequency units or a second set of antenna ports, wherein at least one of the second set of frequency units or the second set of antenna ports includes at least one of less than all available frequency units or less than all available antenna ports; and
generate, based on the information associated with the CSI, reconstructed CSI for at least one of a third set of frequency units or a third set of antenna ports.

30. (canceled)
